(19) United States
(12) Patent Application Publication
(10) Pub. No.: US 2026/0155448 A1
(43) Pub. Date: Jun. 4, 2026

(54) ELECTROLYTE, ALKALI-ION SECONDARY BATTERY INCLUDING THE SAME, AND METHOD OF PREPARING THE ALKALI-ION SECONDARY BATTERY

(71) Applicant: Samsung Electronics Co., Ltd., Suwon-si (KR)

(72) Inventors: Dongjoon LEE, Suwon-si (KR); Chanhyuk LIM, Suwon-si (KR)

(21) Appl. No.: 19/405,740

(22) Filed: Dec. 2, 2025

(30) Foreign Application Priority Data
Dec. 4, 2024 (KR) 10-2024-0178938

(51) Int. Cl. H01M 10/0569; H01M 4/02; H01M 4/525; H01M 4/583; H01M 10/0525; H01M 10/054; H01M 10/0568; H01M 10/058

(52) U.S. Cl. CPC H01M 10/0569; H01M 4/525; H01M 4/583; H01M 10/0525; H01M 10/054; H01M 10/0568; H01M 10/058; H01M 2004/027; H01M 2004/028; H01M 2300/0042

(57) ABSTRACT

An electrolyte, an alkali-ion secondary battery including the electrolyte, and the alkali-ion secondary battery. The electrolyte may include: a primary solvent system including a nitrile solvent represented by Formula 1 and one or more linear carbonate solvents; and a secondary solvent system including two or more cyclic carbonate solvents. The content of the primary solvent system may be about 90 parts by weight to about 99.9 parts by weight, based on 100 parts by weight of total solvent, and the content of the nitrile solvent may be about 20 parts by weight to about 70 parts by weight, based on 100 parts by weight of the total solvent.

### CROSS-REFERENCE TO RELATED APPLICATION

This application claims priority to Korean Patent Application No. 10-2024-0178938, filed on Dec. 4, 2024, in the Korean Intellectual Property Office, and all the benefits accruing therefrom under 35 U.S.C. § 119, the disclosure of which in its entirety is herein incorporated by reference.

### BACKGROUND

### 1. Field

The present disclosure relates to an electrolyte, an alkali-ion secondary battery including the electrolyte, and a method of preparing the alkali-ion secondary battery.

### 2. Description of the Related Art

Alkali-ion secondary batteries currently require extended charging periods, which poses a significant barrier to expansion of their market share in the electric vehicle battery market. The current rapid charging time is approximately 30 minutes. One approach to reduce the charging time involves the application of relatively thin electrodes similar to those employed in the batteries for power tools. However, the implementation of thin electrodes results in a decrease in energy density, which essentially rules out the application of thin electrodes in electric vehicle batteries.

An alternative approach involves the further development and enhancement of electrolyte performance. Although research has been conducted on various alternatives to carbonate-based solvents, including ester-based solvents and glyme-based solvents, such solvents have not demonstrated sufficient improvements in electrochemical stability and cell performance when subjected to high-rate and high-current conditions during charging.

Therefore, there remains an unmet need for an electrolyte solvent system with improved electrochemical stability and cell performance under high-rate and high-current charging conditions.

### SUMMARY

Provided is an electrolyte system that improves cell performance by enhancing charging capacity and high-temperature life characteristics. The electrolyte system is believed to reduce initial cell resistance at room and elevated temperatures as well as reduce direct current internal resistance (DC-IR), while maintaining electrochemical stability under high-rate and high-current charging conditions.

Provided is an alkali-ion secondary battery including the electrolyte.

Provided is a method of preparing the alkali-ion secondary battery.

Additional aspects will be set forth in part in the description which follows and, in part, will be apparent from the description, or may be learned by practice of the presented embodiments of the disclosure.

According to an aspect of the disclosure, the electrolyte includes:
a primary solvent system including a nitrile solvent represented by Formula 1 and one or more linear carbonate solvents; and
a secondary solvent system including two or more cyclic carbonate solvents,
wherein a content of the primary solvent system is about 90 parts by weight to about 99.9 parts by weight based on 100 parts by weight of total solvent, and
wherein a content of the nitrile solvent is about 20 parts by weight to about 70 parts by weight based on 100 parts by weight of the total solvent:

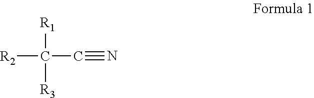

wherein in Formula 1,
one of R₁, R₂, and R₃ may be hydrogen, and
two of R₁, R₂, and R₃ may be independently an unsubstituted C1-C3 alkyl group.

According to an embodiment, the nitrile solvent may include one or more nitrile solvents selected from isobutyronitrile, 2-methylbutanenitrile, 2,2-dimethylbutanenitrile, 2-ethylbutanenitrile, 2-ethylpentanenitrile, or 2-propylpentanenitrile.

According to an embodiment, the molecular weight of the nitrile solvent may be 50 g/mol to 150 g/mol.

According to an embodiment, the linear carbonate solvent may include one or more solvents selected from dimethyl carbonate (DMC), diethyl carbonate (DEC), ethyl methyl carbonate (EMC), dipropyl carbonate (DPC), methyl propyl carbonate (MPC), ethyl propyl carbonate (EPC), methyl ethyl carbonate (MEC), methyl propionate (MP), ethyl propionate, and propyl propionate (PP).

According to an embodiment, in the primary solvent system, the weight ratio of the linear carbonate solvent to the nitrile solvent may be about 3:7 to about 7:3.

According to an embodiment, the cyclic carbonate solvent may include two or more cyclic carbonate solvents selected from ethylene carbonate (EC), propylene carbonate (PC), butylene carbonate (BC), fluoro-ethylene carbonate (FEC), vinylene carbonate (VC), and vinyl ethylene carbonate (VEC).

According to an embodiment, the electrolyte may further include an alkali salt, and the concentration of the alkali salt may be less than 2.0 moles per liter (M).

According to an embodiment, the alkali salt may include one or more salts selected from LiPF6, LiBF4, LiSbF6, LiAsF6, LiClO4, LiCF3SO3, Li(CF3SO2)2N, LiC4F9SO3, LiAlO2, LiAlC4, LiN(CxF2x+1SO2)(C_{y}F2y+1SO2) (where x and y are natural numbers), LiCl, Lil, lithium difluoro(oxalato)borate (LiDFOB), lithium bis(oxalato)borate (LiBOB), lithium difluoro bis(oxalato)borate (LiDFOP), lithium difluorophosphate (LiPO2F2), (CF3SO2)2NLi, (FSO2)2NLi, NaClO4, NaPF6, NaBF4, NaCF3SO3, NaN(CF3SO2)2, NaN(C2F5SO2)2, or NaC(CF3SO2)3.

According to an embodiment, the electrolyte may allow a current application of 3 C-rate or higher during charging.

According to an embodiment, the electrolyte may be used in an alkali-ion secondary battery.

According to another aspect of the disclosure, the alkali-ion secondary battery includes
a positive electrode, a negative electrode, and an electrolyte disposed between the positive electrode and the negative electrode,
wherein the electrolyte is an electrolyte in accordance with an embodiment described herein.

According to an embodiment, the positive electrode may have a capacity of 3 milliampere-hour per square centimeter (mAh/cm²) or more per unit area.

According to an embodiment, the positive electrode may include a positive electrode active material including an alkali metal-containing oxide.

According to an embodiment, the positive electrode active material may include a compound represented by Formula 11 or Formula 12.

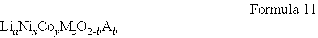

In Formula 11,
a and b may satisfy 1.0≤a≤s 1.2, and 0≤b≤0.2,
x, y, and z may satisfy 0.6≤x<1, 0<y≤0.3, 0<z≤0.3, and x+y+z=1,
M may be one or more elements selected from manganese (Mn), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), and boron (B), and
A may be F, S, Cl, Br, or a combination thereof.

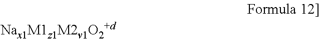

In Formula 12,
M1 may be one or more elements selected from iron (Fe), manganese (Mn), cobalt (Co), nickel (Ni), ruthenium (Ru), osmium (Os), chromium (Cr), molybdenum (Mo), and tungsten (W),
M2 may be one or more elements selected from Groups 4, 5, 7, 9, and 10 of the periodic table, and
x1, z1, v1, and d may satisfy 0.3≤x1<2, 0<z1≤5, 0≤v1≤0.7, and 0≤d<1.

According to an embodiment, the negative electrode may include an negative electrode active material selected from a silicon-based compound, a carbon-based compound, a composite of a silicon-based compound and a carbon-based compound, a silicon oxide (SiOₓ, 0<x<2), or a combination thereof.

According to an embodiment, the carbon-based compound may include carbon nanotubes, carbon black, graphite, or a combination thereof.

According to an embodiment, a separator may be further included between the positive electrode and the negative electrode, wherein a thickness of the separator may be less than 20 micrometers (μm).

According to an embodiment, the alkali-ion secondary battery may be a lithium-ion secondary battery, a sodium-ion secondary battery, or a potassium-ion secondary battery.

According to another embodiment, a method of preparing an alkali-ion secondary battery is provided, the method including:
preparing a positive electrode including a positive electrode active material including an alkali metal-containing oxide;
preparing a negative electrode including a negative electrode active material including an anode active material selected from a silicon-based compound, a carbon-based compound, a composite of a silicon-based compound and a carbon-based compound, a silicon oxide (SiOₓ, 0<x<2), or a combination thereof; and
providing an electrolyte between the positive electrode and the negative electrode;
wherein the electrolyte in accordance with an embodiment described herein.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 shows the charging rate characteristics of lithium-ion secondary batteries (coin cells) prepared in Reference Example 1 and Comparative Examples 1 to 5;

FIG. 2 shows charging rate characteristics of lithium-ion secondary batteries (coin cells) prepared in Examples 1 to 4, Reference Example 1, and Comparative Example 1, according to increasing C-rates of 0.2 C/1.0 C/2.0 C/3.0 C/4.0 C/5.0 C/6.0 C;

FIG. 3 shows high-temperature lifespan characteristics at 45° C. of lithium-ion secondary batteries (coin cells) of Examples 5, 6, and 7 and Comparative Examples 6, 7, and 8;

FIG. 4A shows initial overall cell resistance and direct current internal resistance (DC-IR) results at room temperature (25° C.) for lithium-ion secondary batteries (coin cells) of Examples 2, 5, and 6 and Comparative Example 6;

FIG. 4B shows initial overall cell resistance and direct current internal resistance (DC-IR) results at high temperature (45° C.) for lithium-ion secondary batteries (coin cells) of Examples 2, 5, and 6 and Comparative Example 6;

FIG. 5A shows measured charging capacity results at 3.0 C for lithium-ion secondary batteries (coin cells) of Examples 1, 7, and 8;

FIG. 5B shows measured charging capacity results at 3.0 C for lithium-ion secondary batteries (coin cells) of Comparative Examples 1 and 9 to 12;

FIG. 6A shows initial overall cell resistance and DC-IR results at room temperature (25° C.) for lithium-ion secondary batteries (coin cells) of Examples 1, 7, and 8;

FIG. 6B shows initial overall cell resistance and DC-IR results at room temperature (25° C.) for lithium-ion secondary batteries (coin cells) of Comparative Examples 1 and 9 to 12; and

FIG. 7 is a schematic diagram of an alkali-ion secondary battery according to an embodiment.

### DETAILED DESCRIPTION

Reference will now be made in detail to embodiments. In this regard, the present embodiments may have different forms and should not be construed as being limited to the descriptions set forth herein. Accordingly, the embodiments are merely described below, by referring to the figures, to explain aspects.

The present inventive concept described below may have various modifications and multiple embodiments. Specific embodiments are illustrated in the drawings and described in detail in the detailed description. However, this should not be construed as limiting the present inventive concept to specific embodiments, but should be understood to include all modifications, equivalents, or substitutes falling within the technical scope of the present inventive concept.

In the present specification, the expressions “at least one”, “one or more”, or “one or more than one” preceding elements do not mean supplementing the list of all elements or supplementing individual elements in the above description. In the present specification, the term “combination” includes mixtures, alloys, reaction products, etc., unless specifically stated otherwise. In the present specification, the terms “comprises” and/or “comprising”, or “includes” and/or “including” “includes”, unless otherwise indicated, specify the presence of an element or/and component, but do not preclude the presence or addition of one or more other elements or/and components.

In the present specification, terms such as “first”, “second”, “third”, “primary”, “secondary”, “tertiary”, etc. do not indicate order, quantity, or importance, but are used to distinguish one element from another. In the present specification, unless otherwise indicated or clearly contradicted by context, terms should be interpreted to include both singular and plural forms. As used herein, the term “or” means “and/or” unless otherwise specified.

Throughout the present specification, terms such as “an embodiment” or “embodiment” mean that specific elements described in relation to the embodiment are included in at least one embodiment disclosed in the present specification and may or may not be present in other embodiments. Furthermore, it should be understood that the described elements may be combined in any suitable manner across various embodiments.

Unless otherwise specified, all percentages, parts, ratios, etc. are by weight. Also, when a quantity, concentration, or other value or parameter is given as a range, preferred range, or a list of upper preferable values and lower preferable values, this should be understood as specifically disclosing all ranges formed by any pair of any upper range limit or preferred value and any lower range limit or preferred value, regardless of whether ranges are separately disclosed.

When a range of numerical values is mentioned in the present specification, unless otherwise specified, the range is intended to include its endpoints and all integers and fractions within that range. The scope of the present invention is not intended to be limited by the specific values mentioned when defining ranges.

Unless otherwise specified, the unit “parts by weight” means the weight ratio between components, and the unit “parts by mass” means the weight ratio between components converted to solid content.

In the present specification, “about” includes the mentioned value and means within an acceptable deviation range for a specific value as determined by one of ordinary skill in the art considering errors associated with the measurement and measurement of specific quantities (i.e., limitations of measurement systems). For example, “about” may mean within one or more standard deviations, or within ±10%, or ±5% of the specified value.

Unless otherwise defined, all terms used in the present specification (including technical and scientific terms) have the same meaning as commonly understood by one of ordinary skill in the art to which this disclosure belongs. It should also be understood that terms such as those defined in commonly used dictionaries should be interpreted as having meanings consistent with their meaning in the context of the relevant art and the present disclosure, and should not be interpreted in an idealized sense. Nor should they be interpreted in an overly formal sense.

Liquid electrolytes in alkali-ion secondary batteries are chemically unstable near the potential of alkali metal electrodes, for example, near Li/Li⁺, and therefore rapidly generate gaseous byproducts or form a solid electrolyte interphase (SEI) film. Such instability increases alkali metal inventory loss and cell resistance, and the deposited alkali metal may form dendrites and cause internal micro-short circuits. Moreover, when the negative electrode becomes thicker in a high-energy-density cell, alkali-ion transport in the electrolyte dominates the overpotential. To improve the mobility of alkali ions in the electrolyte, higher ionic conductivity and lower viscosity of the liquid electrolyte become important.

To address some of the aforementioned challenges, the inventors of the present disclosure propose a novel electrolyte (or electrolyte system), an alkali-ion secondary battery including the electrolyte (electrolyte system), and a method of preparing the alkali-ion secondary battery.

Hereinafter, a novel electrolyte, an alkali-ion secondary battery including the electrolyte, and a method of preparing the alkali-ion secondary battery will be described in greater detail through embodiments.

### Electrolyte System

According to an embodiment, the electrolyte includes a primary solvent system including a nitrile solvent represented by Formula 1 and one or more linear carbonate solvents, and a secondary solvent system including two or more cyclic carbonate solvents:

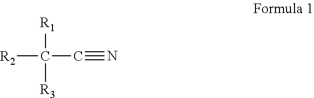

wherein in Formula 1,
one of R₁, R₂, and R₃ may be a hydrogen atom, and
two of R₁, R₂, and R₃ may independently be an unsubstituted C1-C3 alkyl group.

According to an embodiment, the nitrile solvent represented by Formula 1 in the primary solvent system may be a secondary nitrile solvent.

According to an embodiment, the nitrile solvent represented by Formula 1 in the primary solvent system may be a non-cyclic nitrile solvent.

Compared with a general carbonate-based solvent-containing electrolyte, an electrolyte containing a secondary nitrile solvent may exhibit excellent stability, that is, with relative minimal decomposition or degradation by oxidation/reduction electrochemical reactions under high-rate and high-current conditions during charging and discharging of the battery. In contrast, an electrolyte containing a primary nitrile solvent may more readily decompose or degrade in the electrolyte by oxidation/reduction electrochemical reactions during the same charging and discharging conditions of a battery. Moreover, although the inventors find an electrolyte containing a tertiary nitrile solvent is stable in electrochemical reactions during certain charging and discharging, the electrolyte is shown to decompose or degrade to a greater extent under high-rate and high-current conditions.

According to an embodiment, the nitrile solvent may include one or more solvents selected from isobutyronitrile, 2-methylbutanenitrile, 2,2-dimethylbutanenitrile, 2-ethylbutanenitrile, 2-ethylpentanenitrile, and 2-propylpentanenitrile. For example, the nitrile solvent may be isobutyronitrile, 2-methylbutanenitrile, or 2,2-dimethylbutanenitrile.

According to an embodiment, the molecular weight of the nitrile solvent may be about 50 g/mol to about 150 g/mol. For example, the molecular weight of the nitrile solvent may be about 51 g/mol to about 148 g/mol, about 53 g/mol to about 145 g/mol, about 55 g/mol to about 142 g/mol, about 57 g/mol to about 140 g/mol, about 60 g/mol to about 138 g/mol, about 62 g/mol to about 135 g/mol, or about 65 g/mol to about 132 g/mol. When the molecular weight of the nitrile solvent falls within the aforementioned range, the electrolyte maintains the mobility of alkali ions during rapid charging without reducing its viscosity, thereby sustaining electrochemical stability and achieving improved cell performance such as enhanced rate characteristics.

According to an embodiment, the primary solvent system may include one or more linear carbonate solvents that, under high-rate and high-current conditions during charging, lower the viscosity of the electrolyte and improve the mobility of alkali ions, thereby enhancing cell performance such as rate characteristics.

According to an embodiment, the linear carbonate solvent may include one or more solvents selected from dimethyl carbonate (DMC), diethyl carbonate (DEC), ethyl methyl carbonate (EMC), dipropyl carbonate (DPC), methyl propyl carbonate (MPC), ethyl propyl carbonate (EPC), methyl ethyl carbonate (MEC), methyl propionate (MP), ethyl propionate, and propyl propionate (PP). For example, the linear carbonate solvent may include one or more solvents selected from dimethyl carbonate (DMC), diethyl carbonate (DEC), ethyl methyl carbonate (EMC), dipropyl carbonate (DPC), methyl propyl carbonate (MPC), ethyl propyl carbonate (EPC), and methyl ethyl carbonate (MEC).

According to an embodiment, the content of the primary solvent system may be about 90 parts by weight to about 99.9 parts by weight based on 100 parts by weight of total solvent, i.e., the total solvent of the electrolyte. For example, the content of the primary solvent system may be about 90 parts by weight to about 99.5 parts by weight, about 90 parts by weight to about 99 parts by weight, about 90 parts by weight to about 98 parts by weight, about 90 parts by weight to about 97 parts by weight, about 90 parts by weight to about 96 parts by weight, or about 90 parts by weight to about 95 parts by weight, based on 100 parts by weight of the total solvent.

According to an embodiment, the content of the nitrile solvent may be about 20 parts by weight to about 70 parts by weight based on 100 parts by weight of the total solvent. For example, the content of the nitrile solvent may be about 25 parts by weight to about 65 parts by weight, about 30 parts by weight to about 65 parts by weight, or about 35 parts by weight to about 65 parts by weight, based on 100 parts by weight of the total solvent.

According to an embodiment, in the primary solvent system, the weight ratio of the linear carbonate solvent to the nitrile solvent may be about 3:7 to about 7:3. For example, in the primary solvent system, the weight ratio of the linear carbonate solvent to the nitrile solvent may be about 4:6 to about 6:4.

When one or more of the content of the primary solvent system, the content of the nitrile solvent, or the weight ratio of the linear carbonate solvent to the nitrile solvent is within the aforementioned range, the viscosity of the electrolyte may be lowered under high-rate and high-current conditions during charging, which in turn, improves upon alkali-ion mobility and enhances cell performance such as rate characteristics.

According to an embodiment, the electrolyte may include a secondary solvent system including two or more cyclic carbonate solvents. Cyclic carbonate solvents may form a solid electrolyte interphase (SEI) on the surface of the negative electrode. When a high rate and high current are applied during charging and discharging, the SEI on the surface of the negative electrode may offer excellent stability with minimal decomposition or degradation by oxidative/reductive electrochemical reactions in the electrolyte. As a result, the electrolyte according to an embodiment may enhance cell performance, such as high-temperature lifespan characteristics. In contrast, when an electrolyte containing glyme-based solvents is subjected to high-rate and high-current charging and discharging, such an electrolyte may undergo an overvoltage condition and may more readily decompose by oxidative/reductive electrochemical reactions.

According to an embodiment, the cyclic carbonate solvent may include two or more solvents selected from ethylene carbonate (EC), propylene carbonate (PC), butylene carbonate (BC), fluoro-ethylene carbonate (FEC), vinylene carbonate (VC), and vinyl ethylene carbonate (VEC). For example, the cyclic carbonate solvent may include two or more solvents selected from ethylene carbonate (EC), propylene carbonate (PC), fluoro-ethylene carbonate (FEC), and vinylene carbonate (VC).

According to an embodiment, the electrolyte may further include an alkali salt, wherein the concentration of the alkali salt may be less than 2.0 moles per liter (M). For example, the alkali salt may be a lithium salt, a sodium salt, or a potassium salt. For example, the alkali salt may be a lithium salt or a sodium salt. Dissolved in the above-described solvent, the alkali salt may serve as a source of alkali ions within the cell, enabling operation of the alkali-ion secondary battery and facilitating the movement of alkali ions between the positive electrode and the negative electrode.

According to an embodiment, the concentration of the alkali salt may be from about 0.1 M to less than about 2.0 M, from about 0.2 M to less than about 2.0 M, from about 0.3 M to less than about 2.0 M, from about 0.4 M to less than about 2.0 M, from about 0.5 M to less than about 2.0 M, or from about 0.6 M to less than about 2.0 M.

When the concentration of the alkali salt is within the aforementioned range, the electrolyte may exhibit excellent performance by maintaining suitable conductivity and viscosity, thereby allowing alkali ions to move effectively.

According to an embodiment, the alkali salt may include one or more salts selected from LiPF₆, LiBF₄, LiSbF₆, LiAsF₆, LiClO₄, LiCF₃SO₃, Li(CF₃SO₂)₂N, LiC₄F₉SO₃, LiAlO₂, LiAlC₁₄, LiN(CₓF₂ₓ₊₁SO₂)(C_{y}F_{2y+1}SO₂) (where x and y are natural numbers), LiCl, Lil, lithium difluoro(oxalato)borate (LiDFOB), lithium bis(oxalato)borate (LiBOB), lithium difluoro bis(oxalato)borate (LiDFOP), lithium difluorophosphate (LiPO₂F₂), (CF₃SO₂)₂NLi, (FSO₂)₂NLi, NaClO₄, NaPF₆, NaBF₄, NaCF₃SO₃, NaN(CF₃SO₂)₂, NaN(C₂F₅SO₂)₂, or NaC(CF₃SO₂)₃.

According to an embodiment, the electrolyte may allow a current application of 3 C-rate or higher during charging. For example, the electrolyte may allow a current application of 4 C-rate or higher, 5 C-rate or higher, or 6 C-rate or higher, during charging.

According to an embodiment, the electrolyte may be used in an alkali-ion secondary battery. According to an embodiment, the alkali-ion secondary battery may be a lithium-ion secondary battery, a sodium-ion secondary battery, or a potassium-ion secondary battery.

### Alkali-Ion Secondary Battery

According to another embodiment, an alkali-ion secondary battery may include a positive electrode, a negative electrode, and an electrolyte between the positive electrode and the negative electrode, wherein the electrolyte may be the electrolyte described above.

According to an embodiment, the alkali-ion secondary battery may be a lithium-ion secondary battery or a sodium-ion secondary battery.

### 1. Lithium-Ion Secondary Battery

### Positive Electrode

The positive electrode may include a positive electrode current collector and a positive electrode active material layer containing a positive electrode active material.

According to an embodiment, the positive electrode current collector may use a metal substrate. Examples of the metal substrate may include aluminum (Al), indium (In), copper (Cu), magnesium (Mg), stainless steel, titanium (Ti), iron (Fe), cobalt (Co), nickel (Ni), zinc (Zn), germanium (Ge), lithium (Li), or an alloy thereof. The positive electrode current collector may be in a plate or foil form. The positive electrode current collector may be omitted.

The positive electrode active material in the positive electrode active material layer may be any material commonly used in lithium-ion secondary batteries without limitation, but may include a positive electrode active material containing a lithium metal-containing oxide.

According to an embodiment, the positive electrode active material may include one or more composite oxides of a metal selected from cobalt, manganese, nickel, or a combination thereof, with lithium. Specific examples of such positive electrode active materials include compounds represented by any one of the following formulas: LiₐA_{1-b}B′_{b}D′₂ (in this formula, 0.90≤a≤1.8, and 0≤b≤0.5); LiₐE_{1-b}B′_{b}O_{2-c}D′_{c} (in this formula, 0.90≤a≤1.8, 0≤b≤0.5, and 0≤c≤0.05); LiE_{2-b}B′_{b}O_{4-c}D′_{c} (in this formula, 0≤b≤0.5, and 0≤c≤0.05); LiₐNi_{1-b-c}Co_{b}B′_{c}D′_{α} (in this formula, 0.90≤a≤1.8, 0≤b≤0.5, 0≤c≤0.05, and 0<α≤2); LiₐNi_{1-b-c}Co_{b}B′_{c}O_{2-α}F′_{α} (in this formula, 0.90≤a≤1.8, 0≤b≤0.5, 0≤c≤0.05, and 0<α≤2); LiₐNi_{1-b-c}Co_{b}B′_{c} O_{2-α}F′₂ (in this formula, 0.90≤a≤1.8, 0≤b≤0.5, 0≤c≤0.05, and 0<α≤2); LiₐNi_{1-b-c}Mn_{b}B′_{c}D′_{α} (in this formula, 0.90≤a≤1.8, 0≤b≤0.5, 0≤c≤0.05, and 0<a≤2); LiₐNi_{1-b-c}Mn_{b}B′_{c} O_{2-α}F′_{α} (in this formula, 0.90≤a≤1.8, 0≤b≤0.5, 0≤c≤0.05, and 0<a≤2); LiₐNi_{1-b-c}Mn_{b}B′_{c} O_{2-α}F′₂ (in this formula, 0.90<a≤1.8, 0≤b≤0.5, 0≤c≤0.05, and 0<a≤2); LiₐNi_{b}E_{c}G_{d}O₂ (in this formula, 0.90≤a≤s 1.8, 0≤b≤0.9, 0≤c≤0.5, and 0.001≤d≤0.1); LiₐNi_{b}Co_{c}Mn_{d}GₑO₂ (in this formula, 0.90≤a≤1.8, 0≤b≤0.9, 0≤c≤0.5, 0≤d≤0.5, and 0.001≤e≤0.1); LiₐNiG_{b}O₂ (in this formula, 0.90≤a≤1.8 and 0.001≤b≤0.1); LiₐCoG_{b}O₂ (in this formula, 0.90≤a≤1.8 and 0.001≤b≤0.1); LiₐMnG_{b}O₂ (in this formula, 0.90<a≤1.8 and 0.001≤b≤0.1); LiₐMn₂G_{b}O₄ (in this formula, 0.90≤a≤1.8, and 0.001≤b≤0.1); QO₂; QS₂; LiQS₂; V₂O₅; LiV₂O₂; Lil′O₂; LiNiVO₄; Li_{(3-f)}J₂(PO₄)₃ (0≤f≤2); Li_{(3-f)}Fe₂(PO₄)₃ (0≤f≤2); and LiFePO₄. In the aforementioned formulas, A may be Ni, Co, Mn, or a combination thereof; B′ may be Al, Ni, Co, Mn, Cr, Fe, Mg, Sr, V, a rare-earth element, or a combination thereof; D′ may be 0, F, S, P, or a combination thereof; E may be Co, Mn, or a combination thereof; F′ may be F, S, P, or a combination thereof; G may be Al, Cr, Mn, Fe, Mg, La, Ce, Sr, V, or a combination thereof; Q may be Ti, Mo, Mn, or a combination thereof; I′ may be Cr, V, Fe, Sc, Y, or a combination thereof; and J may be V, Cr, Mn, Co, Ni, Cu, or a combination thereof. For example, the positive electrode active material may include one or more selected from lithium cobalt oxide, lithium nickel oxide, lithium nickel cobalt oxide, lithium nickel cobalt aluminum oxide, lithium nickel cobalt manganese oxide, lithium manganese oxide, lithium iron phosphate, nickel sulfide, copper sulfide, lithium sulfide, iron oxide, and vanadium oxide. For example, the positive electrode active material may be LiCoO₂, LiMnₓO₂ₓ (x=1, 2), LiNi₁₋ₓMnₓO₂ₓ (0≤x<1), Ni_{1-x-y}CoₓMn_{y}O₂ (0≤x≤0.5 and 0≤y≤0.5), LiNi_{1-x-y}MnₓAl_{y}O₂ (0<x<1 and 0<y<1), LiFePO₄, TiS₂, FeS₂, TiS₃, or FeS₃.

According to an embodiment, the positive electrode active material may include a compound represented by Formula 11.

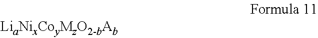

In Formula 11,
a and b may satisfy 1.0≤a≤1.2 and 0≤b≤0.2, and x, y and z may satisfy 0.6≤x<1, 0<y≤0.3, 0<z≤0.3, and x+y+z=1.

M may be one or more selected from manganese (Mn), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), or boron (B), and A may be F, S, Cl, Br, or a combination thereof.

According to an embodiment, the positive electrode active material may include a lithium salt of a transition metal oxide, among lithium transition metal oxides, that has a layered rock salt type structure. The term “layered rock salt type structure” refers to a structure in which layers of oxygen atoms and metal atoms are alternately and regularly arranged along the <111> direction of a cubic rock salt type structure, thereby causing each atomic layer to form a two-dimensional plane. The term “cubic rock salt type structure” refers to a sodium chloride (NaCl) type crystal structure, in which face-centered cubic lattices (fcc) that respectively form cations and anions are displaced by half the length of the ridge of a unit lattice, resulting in the overall arrangement. Lithium transition metal oxides having such a layered rock salt type structure include ternary lithium transition metal oxides, such as LiNiₓCo_{y}Al_{z}O₂ (NCA) or LiNiₓCo_{y}Mn_{z}O₂ (NCM) (0<x<1, 0<y<1, 0<z<1, and x+y+z=1). When the positive electrode active material includes a ternary lithium transition metal oxide having a layered rock salt type structure, the energy density and thermal stability of the lithium-ion secondary battery can be further improved.

According to an embodiment, the positive electrode active material may be covered by a coating layer. The coating layer may be any coating layer for a positive electrode active material of a lithium-ion secondary battery that is known in the art. For example, the coating layer may be Li₂O—ZrO₂ or the like.

When the positive electrode active material according to an embodiment is a ternary lithium transition metal oxide, such as NCA or NCM, and includes nickel (Ni), it is possible to increase the capacity density of the lithium-ion secondary battery and reduce metal dissolution from the positive electrode active material under a charged state. As a result, the cycle characteristics during charging of the lithium-ion secondary battery are improved.

According to an embodiment, the shape of the positive electrode active material may be, for example, spherical or ellipsoidal particles. The particle size of the positive electrode active material is not particularly limited and may be within a range applicable to the positive electrode active material of a general lithium-ion secondary battery.

According to an embodiment, the content of the positive electrode active material in the positive electrode is not limited and may be within a range applicable to positive electrodes in a general lithium-ion secondary battery.

According to an embodiment, the positive electrode active material layer may further include a conductive material and a binder. For example, the conductive material may include carbon black, carbon fibers, graphite, or a combination thereof. For example, the carbon black may be acetylene black, Ketjen black, Super P carbon, channel black, furnace black, lamp black, thermal black, or a combination thereof. The graphite may be natural graphite or artificial graphite. For the conductive material, a combination including at least one of the aforementioned examples may be used.

According to an embodiment, the positive electrode active material layer may further include an additional conductive material having a different composition from the aforementioned conductive material. The additional conductive material may be an electrically conductive fiber such as a metal fiber, a fluorinated carbon powder, a metal powder such as aluminum powder or nickel powder, a conductive whisker such as zinc oxide or potassium titanate, a polyethylene derivative, or a combination thereof. The content of the conductive material may be in a range of about 1 part by weight to about 10 parts by weight, for example, a range of about 2 parts by weight to about 7 parts by weight, based on 100 parts by weight of the positive electrode active material. When the amount of the conductive material is within, for example, a range of about 1 part by weight to about 10 parts by weight, the positive electrode may exhibit suitable electrical conductivity.

A binder may improve the adhesive force among the components of the positive electrode and the adhesion to the positive electrode current collector. Examples of the binder may include polyacrylic acid (PAA), polyvinylidene fluoride, polyvinyl alcohol (PVA), carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene rubber, fluorinated rubber, copolymers thereof, or combinations thereof. The content of the binder may be within a range of about 1 part by weight to about 10 parts by weight, for example, within a range of about 2 parts by weight to about 7 parts by weight, based on 100 parts by weight of the positive electrode active material. If the content of the binder is within the aforementioned ranges, the adhesion of the positive electrode active material layer to the positive electrode current collector may be further improved such that a decrease in the energy density of the positive electrode active material layer can be suppressed.

N-methylpyrrolidone, acetone, and/or water may be utilized as a solvent. Each of the positive electrode active material, the conductive material, the binder, and the solvent may be used in an amount commonly used in a lithium-ion secondary battery.

It may be possible to create pores within the positive electrode active material layer by adding a plasticizer to the positive electrode active material layer.

According to an embodiment, the positive electrode may have a capacity of 3 mAh/cm² or higher per unit area.

### Negative Electrode

The negative electrode includes a negative electrode current collector and a negative electrode active material layer containing a negative electrode active material.

According to an embodiment, the negative electrode current collector may be selected from copper foil, nickel foil, stainless steel foil, titanium foil, nickel foam, copper foam, a polymer substrate coated with a conductive metal, or a combination thereof. The negative electrode current collector may also be omitted.

The negative electrode active material in the negative electrode active material layer may be any material commonly used in lithium-ion secondary batteries without limitation, and may include a material or a transition metal oxide that can reversibly intercalate and deintercalate lithium ions.

According to an embodiment, the negative electrode active material may be a material capable of reversibly intercalating and deintercalating lithium ions. For example, the negative electrode active material may include one or more selected from silicon-based compounds, carbon-based compounds, a composite of a silicon-based compound and a carbon-based compound, and silicon oxide (SiOₓ, 0≤x<2).

According to an embodiment, the negative electrode active material may be a carbon-based compound. The carbon-based compound may employ any commonly used carbon-based negative electrode active material, and may employ, for example, crystalline carbon, amorphous carbon, or a combination thereof.

Examples of crystalline carbon may include graphite, such as natural graphite or artificial graphite, in an amorphous, plate-shaped, flake-shaped, spherical, or fibrous form. Examples of amorphous carbon may include soft carbon, hard carbon, mesophase pitch carbonized materials, calcined coke, and the like. For example, the carbon-based compound may include carbon nanotubes, carbon black, graphite, or a combination thereof.

According to an embodiment, the negative electrode active material may be an alloy of lithium with a metal selected from Na, K, Rb, Cs, Fr, Be, Mg, Ca, Sr, Si, Sb, Pb, In, Zn, Ba, Ra, Ge, Al, and Sn.

According to an embodiment, the negative electrode active material may be a Si-Q alloy (where Q is selected from alkali metals, alkaline earth metals, Group 13 elements, Group 14 elements, Group 15 elements, Group 16 elements, transition metals, rare-earth elements, and a combination thereof, and Q is not Si), Sn, SnO₂, Sn—R (where R is selected from alkali metals, alkaline earth metals, Group 13 elements, Group 14 elements, Group 15 elements, Group 16 elements, transition metals, rare-earth elements, and a combination thereof, and R is not Sn), or a mixture of two or more of the aforementioned examples with SiO₂. Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, or a combination thereof.

Examples of transition metal oxides may include vanadium oxide, lithium vanadium oxide, lithium titanium oxide, and the like.

According to an embodiment, the particle size of the negative electrode active material is not particularly limited and may be within a range applicable to negative electrode active materials in general lithium-ion secondary batteries.

According to an embodiment, the content of the negative electrode active material in the negative electrode is not limited and may be within a range applicable to negative electrodes in general lithium-ion secondary batteries.

According to an embodiment, the negative electrode active material layer may further include a conductive material and a binder. The conductive material may be the same as the conductive material used in the positive electrode active material layer described above.

As the binder, a water-insoluble binder, a water-soluble binder, or a combination thereof may be used. Examples of the water-insoluble binder may include polyvinyl chloride, carboxylated polyvinyl chloride, polyvinyl fluoride, polyurethane, polytetrafluoroethylene, polyvinylidene fluoride, polyethylene, polypropylene, polyamide-imide, polyimide, or a combination thereof.

Examples of the water-soluble binder may include rubber-based binders or polymer resin binders.

The rubber-based binder may be selected from styrene-butadiene rubber (SBR), acrylated styrene-butadiene rubber, acrylonitrile-butadiene rubber, acrylic rubber, butyl rubber, fluororubber, or a combination thereof.

The polymer resin binder may be selected from polytetrafluoroethylene, ethylene-propylene copolymer, polyethylene oxide, polyvinylpyrrolidone, polyepichlorohydrin, polyphosphazene, polyacrylonitrile, polystyrene, ethylene-propylene-diene polymer, polyvinylpyridine, chlorosulfonated polyethylene, latex, polyester resin, acrylic resin, phenol resin, epoxy resin, polyvinyl alcohol, or a combination thereof.

When a water-soluble binder is used as the negative electrode binder, a cellulose-based compound capable of imparting viscosity may further be included as a thickening agent. The cellulose-based compound may employ a mixture of one or more selected from carboxymethyl cellulose, hydroxypropyl methyl cellulose, methyl cellulose, and alkali metal salts thereof. As the alkali metal, Na, K, or Li may be employed. The contents of the negative electrode active material, the conductive material, the binder, and the thickening agent may be at levels commonly used in lithium-ion secondary batteries.

### Electrolyte and Separator

Since the electrolyte is the same as described above, a detailed explanation thereof will be omitted.

A separator may be additionally included between the positive electrode and the negative electrode.

The separator serves to separate the positive electrode from the negative electrode and provide a path for lithium-ion migration, and any separator commonly used in lithium-ion secondary batteries may be used. For the separator, a separator that exhibits low resistance to lithium-ion transport in the electrolyte and excellent electrolyte retention properties may be employed.

According to an embodiment, the separator may include glass fiber, polyester, polyethylene, polypropylene, polytetrafluoroethylene, or a combination thereof, and may be in a non-woven or woven fabric form.

For example, in a lithium-ion secondary battery, a polyolefin-based polymer separator such as polyethylene or polypropylene may be generally used. For example, the separator may employ a coated separator containing a ceramic component or a polymer material to ensure heat resistance or mechanical strength, and may optionally be used in a single-layer or multi-layer structure.

For example, the separator may utilize any one selected from a multilayer film of two or more layers of polyethylene, polypropylene, polyvinylidene fluoride or a combination thereof, and a mixed-multilayer film, such as a double-layer separator of polyethylene/polypropylene, a triple-layer separator of polyethylene/polypropylene/polyethylene, and a triple-layer separator of polypropylene/polyethylene/polypropylene.

According to an embodiment, the separator may have a thickness of less than 20 μm. When the thickness of the separator is within the aforementioned range, lithium ions may be allowed to move more effectively within the electrolyte, thereby enhancing rapid charging performance.

### 2. Sodium-Ion Secondary Battery

### Positive Electrode

The positive electrode may include a positive electrode current collector and a positive electrode active material layer containing a positive electrode active material.

According to an embodiment, the positive electrode current collector may be selected from metals such as nickel, aluminum, titanium, copper, gold, silver, platinum, an aluminum alloy, or stainless steel; or may be formed by plasma spraying or arc spraying carbon materials, activated carbon fibers, nickel, aluminum, zinc, copper, tin, lead, or an alloy thereof; or may be a conductive film obtained by dispersing a conductive material in a resin, for example, rubber or a styrene-ethylene-butylene-styrene (SEBS) copolymer. For example, aluminum, nickel, or stainless steel may be used. In particular, aluminum may be used due to its ease of processing into thin films and low cost. The shape of the current collector is not particularly limited and may include, for example, a thin film, a flat plate, a mesh, a net, a punched shape, or an embossed shape, or a combination thereof (for example, a mesh-like flat plate). For example, an uneven surface may be formed on the current collector by etching.

The positive electrode active material in the positive electrode active material layer may employ any material commonly used in sodium-ion secondary batteries without limitation, but may include a positive electrode active material containing a sodium metal-containing oxide.

According to an embodiment, the positive electrode active material may include a compound represented by Formula 12:

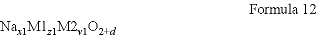

In Formula 12,
M1 may be one or more elements selected from iron (Fe), manganese (Mn), cobalt (Co), nickel (Ni), ruthenium (Ru), osmium (Os), chromium (Cr), molybdenum (Mo), or tungsten (W),
M2 may be one or more elements selected from Groups 4, 5, 7, 9, or 10 of the periodic table, and
x1, z1, v1, and d may satisfy 0.3≤x1<2, 0<z1≤5, 0<v1≤0.7, and 0≤d<1.

According to an embodiment, the positive electrode active material may include oxides represented by NaM¹ₐO₂, such as NaFeO₂, NaMnO₂, NaNiO₂ and NaCoO₂, oxides represented by Na_{0.44}Mn_{1-α}M¹ₐO₂, oxides represented by Na_{0.7}Mn_{1-α}M¹ₐO_{2.05} (where M¹ is one or more transition metal elements, and 0≤a≤1); oxides represented by Na_{b}M²_{c}Si₁₂O₃₀, such as Na₆Fe₂Si₁₂O₃₀ and Na₂Fe₅Si₁₂O₃₀ (where M² is one or more transition metal elements, 2≤b≤6, and 2≤c≤5); oxides represented by Na_{d}M³ₑSi₆O₁₈, such as Na₂Fe₂Si₆O₁₈ and Na₂MnFeSi₆O₁₈ (where M³ is one or more transition metal elements, 3≤d≤6, and 1≤e≤2); oxides represented by Na_{f}M⁴_{g}Si₂O₆ such as Na₂FeSiO₆ (where M⁴ is one or more elements selected from the group consisting of transition metal elements, Mg, and Al, 1≤f≤2, and 1≤g≤2); phosphates such as NaFePO₄ and Na₃Fe₂(PO₄)₃; borates such as NaFeBO₄ and Na₃Fe₂(BO₄)₃; and fluorides represented by NahM⁵F₆, such as Na₃FeF₆ and Na₂MnF₆ (where M⁵ is one or more transition metal elements, and 2≤h≤3). However, the positive electrode active material is not necessarily limited to the aforementioned examples and any material that can be used in the art without degrading the performance of sodium batteries is acceptable.

The conductive material may be a high-specific-surface-area carbon material, for example, carbon black, activated carbon, acetylene black, or graphite microparticles, either alone or in a mixture of two or more thereof. Additionally, electrically conductive fibers such as vapor-grown carbon fibers, fibers produced by carbonizing pitch (a by-product of petroleum, coal, or coal tar) at high temperature, or carbon fibers prepared from acrylic fibers (polyacrylonitrile) may be used as the conductive material. Carbon fibers and high-specific-surface-area carbon materials may be used together. Using carbon fibers and high-specific-surface-area carbon materials at the same time may further improve electrical conductivity. Additionally, a metal-based conductive material that is not oxidized and dissolved in the potential range of the positive electrode and that has lower electrical resistance than the positive electrode active material may be used. For example, corrosion-resistant metals such as titanium or gold, carbides such as SiC or WC, or nitrides such as Si₃N₄ or BN may be used. However, the conductive material used in the positive electrode is not necessarily limited to the aforementioned examples, and may employ any material available as conductive material in the art.

The binder may be a polymer of a fluorine compound (i.e., a fluorine-based polymer). For example, the fluorine compound may include: fluoroalkyl (C1-C18) (meth)acrylates; perfluoroalkyl (meth)acrylates (e.g., perfluorododecyl (meth)acrylate, perfluoro-n-octyl (meth)acrylate, perfluoro-n-butyl (meth)acrylate); perfluoroalkyl-substituted alkyl (meth)acrylates (e.g., perfluorohexylethyl (meth)acrylate, perfluorooctylethyl (meth)acrylate); perfluoroalkyl oxyalkyl (meth)acrylates (e.g., perfluorododecyloxyethyl (meth)acrylate and perfluorodecyloxyethyl (meth)acrylate); fluoroalkyl (C1-C18) crotonates; fluoroalkyl (C1-C18) maleates; fluoroalkyl (C1-C18) maleate fumarates; fluoroalkyl (C1-C18) itaconates; fluoroalkyl-substituted olefins (having 2-10 carbon atoms and 1-17 fluorine atoms), for example, perfluorohexylethylene; fluorinated olefins having about 2 to 10 carbon atoms and about 1 to 20 fluorine atoms, in which fluorine atoms are bonded to the double-bonded carbon tetrafluoroethylene; trifluoroethylene; vinylidene fluoride; and hexafluoropropylene.

According to an embodiment, the binder may employ a copolymer of a fluorine compound and a monomer having an ethylenic double bond that does not include a fluorine atom.

In addition, the binder may employ a non-fluorinated polymer.

The non-fluorinated polymer refers to a polymer that does not contain fluorine atoms. For example, the non-fluorinated polymer may be an addition polymer of a monomer containing an ethylenic double bond, free of fluorine atoms. Such monomers may include, for example, (cyclo)alkyl (C1-C22) (meth)acrylate (for example, methyl (meth)acrylate, ethyl (meth)acrylate, n-butyl (meth)acrylate, isobutyl (meth)acrylate, cyclohexyl (meth)acrylate, 2-ethylhexyl (meth)acrylate, isodecyl (meth)acrylate, lauryl (meth)acrylate, octadecyl (meth)acrylate, etc.); aromatic ring-containing (meth)acrylate (for example, benzyl (meth)acrylate, phenylethyl (meth)acrylate, etc.); alkyleneglycol or dialkyleneglycol (2 to 4 carbon atoms in the alkylene group) mono(meth)acrylate (for example, 2-hydroxyethyl (meth)acrylate, 2-hydroxypropyl (meth)acrylate, diethyleneglycol mono(meth)acrylate); (poly)glycerin (polymerization degree of 1 to 4) mono(meth)acrylate; polyfunctional (meth)acrylates [for example, (poly)ethyleneglycol (polymerization degree of 1 to 100) di(meth)acrylate, (poly)propyleneglycol (polymerization degree of 1 to 100) di(meth)acrylate, 2,2-bis(4-hydroxyethylphenyl)propane di(meth)acrylate, trimethyloIpropane tri(meth)acrylate, etc.] as (meth)acrylic acid ester-based monomers; (meth)acrylamide, (meth)acrylamide derivatives (for example, N-methylol (meth)acrylamide, diacetoneacrylamide, etc.) as (meth)acrylamide-based monomers; (meth)acrylonitrile, 2-cyanoethyl (meth)acrylate, 2-cyanoethyl acrylamide, etc. as cyano group-containing monomers; styrene and styrene derivatives having 7 to 18 carbon atoms (for example, α-methylstyrene, vinyltoluene, p-hydroxystyrene, and divinylbenzene, etc.) as styrene-based monomers; alkadienes having 4 to 12 carbon atoms (for example, butadiene, isoprene, chloroprene, etc.) as diene-based monomers; carboxylic acid (C2-C12) vinyl esters (for example, vinyl acetate, vinyl propionate, vinyl butyrate, and vinyl octanoate, etc.), carboxylic acid (C2-C12)(meth)allyl esters (for example, (meth)allyl acetate, (meth)allyl propionate, and (meth)allyl octanoate, etc.) as alkenyl ester-based monomers; glycidyl (meth)acrylate, (meth)allylglycidyl ether, etc. as epoxy group-containing monomers; monoolefins having 2 to 12 carbon atoms (for example, ethylene, propylene, 1-butene, 1-octene, and 1-dodecene, etc.) as monoolefin classes; monomers containing chlorine, bromine, or iodine atoms, as well as vinyl chloride and vinylidene chloride, etc. as non-fluorine halogen atom-containing monomers; (meth)acrylic acid such as acrylic acid and methacrylic acid as (meth)acrylic acid; and conjugated diene-containing monomers such as butadiene, isoprene, etc. For example, the non-fluorinated polymer may be polyethylene, polypropylene, or the like. Further, examples of such addition polymers may include ethylene-vinyl acetate copolymer, styrene-butadiene copolymer, or ethylene-propylene copolymer. In addition, vinyl ester polymers of carboxylic acids may be partially or completely saponified, such as in the case of polyvinyl alcohol.

Moreover, the binder may, for example, be a polysaccharide or a derivative thereof, such as starch, methyl cellulose, carboxymethyl cellulose, hydroxymethyl cellulose, hydroxyethyl cellulose, hydroxypropyl cellulose, carboxymethyl hydroxyethyl cellulose, and nitrocellulose; a phenol resin; a melamine resin; a polyurethane resin; a urea resin; a polyamide resin; a polyimide resin; a polyamide-imide resin; petroleum pitch; or coal pitch. A plurality of binders may be used together. In addition, the binder described above may function as a thickening agent in the electrode mixture.

Examples of solvents include N-methyl-2-pyrrolidone, acetone, or water, although any solvent available in the art may be employed without limitation.

Each of the positive electrode active material, the conductive material, the binder, and the solvent may be at levels commonly used in sodium batteries. Depending on the application and configuration of the sodium battery, one or more of the conductive material, binder, and solvent may be omitted.

According to an embodiment, the positive electrode may have a capacity of 3 mAh/cm² or higher per unit area.

### Negative Electrode

The negative electrode includes a negative electrode current collector and a negative electrode active material layer containing a negative electrode active material.

According to an embodiment, the negative electrode current collector is not limited by material, shape, or manufacturing method, and any current collector may be used. For example, a copper foil with a thickness of 10 μm to 100 μm, a perforated copper foil having a thickness of 10 μm to 100 μm and an apperturediameter of 0.1 mm to 10 mm, an expanded metal, or a foamed metal sheet may be used. In addition to copper, materials such as stainless steel, titanium, or nickel may be used for the negative electrode current collector.

According to an embodiment, the negative electrode active material in the negative electrode active material layer may include sodium metal, a sodium metal-based alloy, a sodium intercalating compound, or a carbon-based material. However, without being limited to the aforementioned examples, any material that contains sodium or can absorb/release sodium and is available as a negative electrode active material in the art, may be employed.

As the negative electrode determines the capacity of a sodium-ion secondary battery, for example, the negative electrode may be sodium metal. Examples of sodium metal-based alloys may include alloys of sodium with aluminum, tin, indium, calcium, titanium, vanadium, and the like.

For example, the negative electrode may employ a sodium metal layer having a thickness of about 3 μm to about 500 μm and may be employed in various forms such as a film, sheet, foil, net, porous body, foam, or nonwoven body.

When a negative electrode active material other than sodium metal or a sodium alloy is used, a carbon-based material having a graphene structure or the like may be used. A mixed negative electrode composed of materials such as graphite or graphitized carbon may be used, or a mixed or composite negative electrode including a carbon-based material and a metal or alloy may be used.

Examples of the carbon-based material may include natural graphite, artificial graphite, mesophase carbon, expanded graphite, carbon fibers, vapor-grown carbon fibers, pitch-based carbon materials, needle coke, petroleum coke, polyacrylonitrile-based carbon fibers, carbon black, or amorphous carbon materials synthesized by pyrolyzing five-membered or six-membered cyclic hydrocarbons or oxygen-containing cyclic organic compounds that can electrochemically intercalate/deintercalate sodium ions.

According to an embodiment, the negative electrode active material layer may further include a conductive material, a binder, and a solvent in addition to the negative electrode active material, which may be the same as those used for the positive electrode.

Each of the negative electrode active material, the conductive material, the binder, and the solvent may be used in an amount commonly used in sodium-ion secondary batteries.

### Electrolyte and Separator

The electrolyte is the same as described above, therefore its description will be omitted.

The separator is not particularly limited provided that its composition can withstand the operating conditions of the sodium-ion secondary battery. Examples of suitable separators may include polymeric nonwoven fabrics such as polypropylene nonwoven fabrics and polyphenylene sulfide nonwoven fabrics, and porous films formed of olefin resins such as polyethylene or polypropylene. Two or more of these materials may be used in combination.

Furthermore, the separator may be selected to have low ionic resistance in the electrolyte and superior electrolyte retention properties. For example, the separator may be selected from glass fiber, polyester, Teflon, polytetrafluoroethylene (PTFE), or combinations thereof, and may be in a nonwoven or woven form.

The polymer resin used to prepare the separator is not particularly limited and may be any of the materials used as binders for the electrode plate. For example, polyethylene, polypropylene, vinylidene fluoride/hexafluoropropylene copolymer, polyvinylidene fluoride (PVDF), polyacrylonitrile, polymethyl methacrylate, or mixtures thereof may be used.

The filler used to prepare the separator may be an inorganic particle or the like. The solvent may be any solvent commonly employed in the art that can dissolve the polymer resin and form pores in the polymer resin upon drying.

In addition, the separator may be separately prepared by another known method, and then laminated onto the top of the negative electrode active material layer.

Furthermore, the separator may additionally contain additives such as nonconductive particles, other fillers, or fibrous compounds for the purpose of controlling properties such as strength, hardness, or heat shrinkage.

For example, the separator may further include inorganic particles. By further including these inorganic particles, oxidation resistance of the separator may be enhanced, and degradation of battery performance may be suppressed.

Examples of the inorganic particles may include alumina (Al₂O₃), silica (SiO₂), and titania (TiO₂). The average particle size of the inorganic particles may be about 10 nm to about 5 μm. If the average particle size is less than 10 nm, the crystallinity of the inorganic particles may be reduced and the additive effect may be minimal; if the average particle size exceeds 5 μm, it may be difficult to achieve satisfactory dispersion of the inorganic particles.

The separator may have a multilayer structure including one or more polymer layers to increase tear strength or mechanical strength. For example, the separator may be a polyethylene/polypropylene laminate, a polyethylene/polypropylene/polyethylene laminate, or a nonwoven/polyolefin laminate.

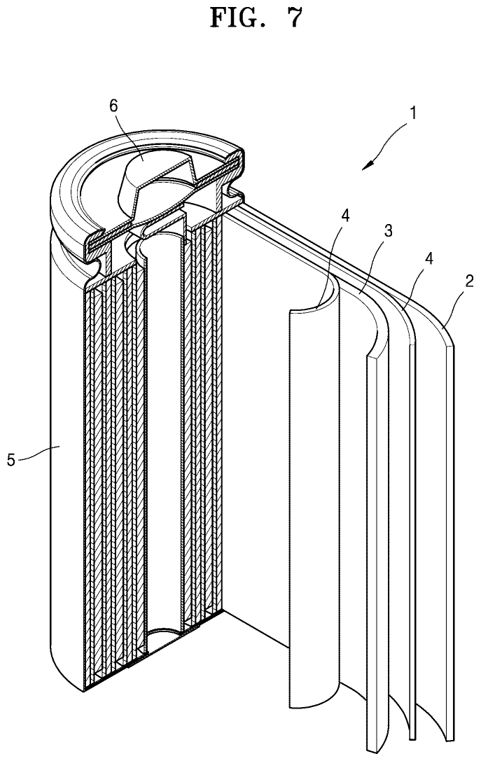

As shown in FIG. 7, an alkali-ion secondary battery 1 may include a positive electrode 3, a negative electrode 2, and a separator 4. The positive electrode 3, the negative electrode 2, and the separator 4 described above may be wound or folded and placed in a battery case 5. The battery case 5 may be then filled with an organic electrolyte solution and sealed with a cap assembly 6, completing the alkali-ion secondary battery 1. The battery case may be cylindrical, prismatic, thin-film, or the like. For example, the alkali-ion secondary battery may be a large thin-film battery.

The aforementioned alkali-ion secondary battery can be charged at a current ranging from about 0.2 C-rate to about 6 C-rate, and thus be suitable for rapid charging.

In addition, the alkali-ion secondary battery due to having excellent storage stability and thermal stability may be used in energy storage systems (ESS) and electric vehicles (EV). For example, the alkali-ion secondary battery may be used in a hybrid vehicle, such as a plug-in hybrid electric vehicle (PHEV) and the like.

### Method of Preparing Alkali-Ion Secondary Battery

According to another embodiment, a method of preparing an alkali-ion secondary batter may include: providing a positive electrode including a positive electrode active material including an alkali metal-containing oxide; providing a negative electrode including a negative electrode active material including one or more anode active materials selected from a silicon-based compound, a carbon-based compound, a composite of a silicon-based compound and a carbon-based compound, and silicon oxide (SiOₓ, 0<x<2); and providing an electrolyte in accordance with an embodiment described herein between the positive electrode and the negative electrode. For example, the electrolyte may include a primary solvent system including a nitrile solvent represented by Formula 1 and one or more linear carbonate solvents, and a secondary solvent system including two or more cyclic carbonate solvents, wherein the content of the primary solvent system may be about 90 parts by weight to about 99.9 parts by weight based on 100 parts by weight of total solvent, and the content of the nitrile solvent may be about 20 parts by weight to about 70 parts by weight based on 100 parts by weight of the total solvent:

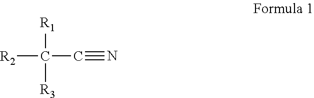

wherein in Formula 1,
one of R₁, R₂, and R₃ may be a hydrogen atom, and
two of R₁, R₂, and R₃ may independently be an unsubstituted C1-C3 alkyl group.

According to an embodiment, the method of preparing an alkali-ion secondary battery can reduce the initial cell resistance and direct current internal resistance (DC-IR) at room temperature and high temperature when a high rate and high current are applied during charging, thereby improving cell performance such as charging capacity and high-temperature lifespan characteristics.

According to an embodiment, for preparing the positive electrode, a positive electrode active material composition is prepared by mixing a positive electrode active material, a conductive material, a binder, and a solvent. The positive electrode active material composition is directly coated on a current collector to form a positive electrode plate. Alternatively, the positive electrode active material composition may be cast onto a separate support, and the film peeled off from the support may be laminated onto a current collector to form a positive electrode plate. The positive electrode is not limited to the forms described above and may be in other forms.

According to an embodiment, the negative electrode may be prepared using the same method as the positive electrode. The conductive material, binder, and solvent in the negative electrode active material composition may be the same as those used for the positive electrode. For example, the negative electrode active material, conductive material, binder, and solvent may be mixed to prepare a negative electrode active material composition, which is then directly coated on a copper current collector to manufacture a negative electrode plate. Alternatively, the negative electrode plate may be prepared by casting the negative electrode active material composition on a separate support, peeling off the resulting negative electrode active material film from the support, and laminating the film onto a copper current collector.

According to an embodiment, in order to prepare a separator, a separator composition may be prepared by mixing a polymer resin, a filler, and a solvent. The separator composition may be coated and dried directly on top of the negative electrode active material layer, thereby forming the separator. Alternatively, after the separator composition is cast and dried on a support, the separator film peeled off from the support may be laminated onto the negative electrode active material layer, thereby forming the separator.

Alternatively, the separator may be prepared by a dry method in which polypropylene or polyethylene is melted and extruded into a film, then annealed at low temperature to grow crystal domains, and subsequently stretched in this state to elongate the amorphous regions, thus forming a microporous membrane.

Alternatively, the separator may be prepared by a wet method in which a hydrocarbon solvent or other low-molecular-weight material is mixed with polypropylene or polyethylene to form a film, and then, once the solvent or low-molecular-weight material starts to form an island phase in the amorphous region, the solvent or low-molecular-weight material is removed using another volatile solvent, thus forming a microporous membrane.

Hereinbelow, examples and comparative examples of the present disclosure are described. However, it should be understood that these examples are provided for illustrative purposes only and the present disclosure is not limited to the examples described below.

### EXAMPLES

### Preparation of Electrolytes

### Preparation Example 1: IBN/DMC/FECNC+LiPF₆ (IBN:DMC=4:6, FEC:VC=8:2, 1 M)

An electrolyte was prepared by adding, based on 100 parts by weight of total solvent, 36 parts by weight of isobutyronitrile (IBN) and 54 parts by weight of dimethyl carbonate (DMC) as the primary solvent system, 8 parts by weight of fluoro-ethylene carbonate (FEC) and 2 parts by weight of vinylene carbonate (VC) as the secondary solvent system, and 1 M LiPF₆ as the lithium salt.

### Preparation Example 2: IBN/DMC/FECNC+LiPF₆ (IBN:DMC=5:5, FEC:VC=8:2, 1 M)

An electrolyte was prepared in the same manner as in Preparation Example 1, except that 45 parts by weight of isobutyronitrile (IBN) and 45 parts by weight of dimethyl carbonate (DMC) were used as the primary solvent system based on 100 parts by weight of the total solvent.

### Preparation Example 3: IBN/DMC/FECNC+LiPF₆ (IBN:DMC=6:4, FEC:VC=8:2, 1 M)

An electrolyte was prepared in the same manner as in Preparation Example 1, except that 54 parts by weight of isobutyronitrile (IBN) and 36 parts by weight of dimethyl carbonate (DMC) were used as the primary solvent system based on 100 parts by weight of the total solvent.

### Preparation Example 4: IBN/EMC/FECNC+LiPF₆ (IBN:DMC=5:5, FEC:VC=8:2, 1 M)

An electrolyte was prepared in the same manner as in Preparation Example 1, except that 45 parts by weight of isobutyronitrile (IBN) and 45 parts by weight of ethyl methyl carbonate (EMC) were used as the primary solvent system based on 100 parts by weight of the total solvent.

### Preparation Example 5: IBN/DMC/EC/FEC+LiPF₆ (IBN:DMC=5:5, EC:FEC=4:4, 1 M)

An electrolyte was prepared in the same manner as in Preparation Example 1, except that based on 100 parts by weight of the total solvent, 46 parts by weight of isobutyronitrile (IBN) and 46 parts by weight of dimethyl carbonate (DMC) were used as the primary solvent system, 4 parts by weight of ethylene carbonate (EC) and 4 parts by weight of fluoro-ethylene carbonate (FEC) were used as the secondary solvent system.

### Preparation Example 6: IBN/DMC/ECNC+LiPF₆ (IBN:DMC=5:5, EC:VC=8:2, 1 M)

An electrolyte was prepared in the same manner as in Preparation Example 1, except that based on 100 parts by weight of the total solvent, 45 parts by weight of isobutyronitrile (IBN) and 45 parts by weight of dimethyl carbonate (DMC) were used as the primary solvent system, 8 parts by weight of ethylene carbonate (EC) and 2 parts by weight of vinylene carbonate (VC) were used as the secondary solvent system.

### Preparation Example 7: IBN/DMC/FECNC+LiPF₆ (IBN:DMC=5:5, FEC:VC=8:2, 0.6 M)

An electrolyte was prepared in the same manner as in Preparation Example 1, except that 45 parts by weight of isobutyronitrile (IBN) and 45 parts by weight of dimethyl carbonate (DMC) were used as the primary solvent system based on 100 parts by weight of the total solvent, and 0.6 M LiPF₆ was added as the lithium salt.

### Preparation Example 8: IBN/DMC/FECNC+LiPF₆ (IBN:DMC=5:5, FEC:VC=8:2, 1.2 M)

An electrolyte was prepared in the same manner as in Preparation Example 1, except that 45 parts by weight of isobutyronitrile (IBN) and 45 parts by weight of dimethyl carbonate (DMC) were used as the primary solvent system based on 100 parts by weight of the total solvent, and 1.2 M LiPF₆ was added as the lithium salt.

### Reference Preparation Example 1: IBN/FEC+LiPF₆ (IBN:FEC=92:8, 1 M)

An electrolyte was prepared by adding, based on 100 parts by weight of total solvent, 92 parts by weight of isobutyronitrile (IBN) and 8 parts by weight of fluoro-ethylene carbonate (FEC), and 1 M LiPF₆ as the lithium salt.

### Comparative Preparation Example 1: EC/DMC/EMC+LiPF₆ (EC:DMC:EMC=3:4:3, 1 M)

An electrolyte was prepared by adding, based on 100 parts by weight of total solvent, 30 parts by weight of ethylene carbonate (EC), 40 parts by weight of dimethyl carbonate (DMC), and 30 parts by weight of ethyl methyl carbonate (EMC), and 1 M LiPF₆ as the lithium salt.

### Comparative Preparation Example 2: AN/FEC+LiPF₆ (AN:FEC=92:8, 1 M)

An electrolyte was prepared by adding, based on 100 parts by weight of total solvent, 92 parts by weight of acetonitrile (AN) and 8 parts by weight of fluoro-ethylene carbonate (FEC) and 1 M LiPF₆ as the lithium salt.

### Comparative Preparation Example 3: n-BN/FEC+LiPF₆ (n-BN:FEC=92:8, 1 M)

An electrolyte was prepared by adding, based on 100 parts by weight of total solvent, 92 parts by weight of n-butyronitrile (n-BN) and 8 parts by weight of fluoro-ethylene carbonate (FEC) and 1 M LiPF₆ as the lithium salt.

### Comparative Preparation Example 4: CPC/FEC+LiPF₆ (CPC:FEC=92:8, 1 M)

An electrolyte was prepared by adding, based on 100 parts by weight of total solvent, 92 parts by weight of cyclopropyl cyanide (CPC) and 8 parts by weight of fluoro-ethylene carbonate (FEC) and 1 M LiPF₆ as the lithium salt.

### Comparative Preparation Example 5: PN/FEC+LiPF₆ (PN:FEC=92:8, 1 M)

An electrolyte was prepared by adding, based on 100 parts by weight of total solvent, 92 parts by weight of pivalonitrile (PN) and 8 parts by weight of fluoro-ethylene carbonate (FEC) and 1 M LiPF₆ as the lithium salt.

### Comparative Preparation Example 6: IBN/DMC/EC+LiPF₆ (IBN:DMC=5:5, EC=8, 1.2 M)

An electrolyte was prepared by adding, based on 100 parts by weight of total solvent, 46 parts by weight of isobutyronitrile (IBN) and 46 parts by weight of dimethyl carbonate (DMC) as the primary solvent system, 8 parts by weight of ethylene carbonate (EC) as the secondary solvent system, and 1 M LiPF₆ as the lithium salt.

### Comparative Preparation Example 7: IBN/DMC/FEC+LiPF₆ (IBN:DMC=5:5, FEC=8, 1.2 M)

An electrolyte was prepared by adding, based on 100 parts by weight of total solvent, 46 parts by weight of isobutyronitrile (IBN) and 46 parts by weight of dimethyl carbonate (DMC) as the primary solvent system, 8 parts by weight of fluoro-ethylene carbonate (FEC) as the additive solvent, and 1 M LiPF₆ as the lithium salt.

### Comparative Preparation Example 8: IBN/DMC/VC+LiPF₆ (IBN:DMC=5:5, VC=8, 1.2 M)

An electrolyte was prepared by adding, based on 100 parts by weight of total solvent, 46 parts by weight of isobutyronitrile (IBN) and 46 parts by weight of dimethyl carbonate (DMC) as the primary solvent system, 8 parts by weight of vinylene carbonate (VC) as the secondary solvent system, and 1 M LiPF₆ as the lithium salt.

### Comparative Preparation Example 9: EC/DMC/EMC+LiPF₆ (EC:DMC:EMC=3:4:3, 0.6 M)

An electrolyte was prepared by adding, based on 100 parts by weight of total solvent, 30 parts by weight of EC, and 40 parts by weight of DMC, 30 parts by weight of EMC, and 0.6 M LiPF₆ as the lithium salt.

### Comparative Preparation Example 10: EC/DMC/EMC+LiPF₆ (EC:DMC:EMC=3:4:3, 1.2 M)

An electrolyte was prepared by adding, based on 100 parts by weight of total solvent, 30 parts by weight of EC, 40 parts by weight of DMC, and 30 parts by weight of EMC, and 1.2 M LiPF₆ as the lithium salt.

### Comparative Preparation Example 11: EC/DMC/EMC+LiPF₆ (EC:DMC:EMC=3:4:3, 2 M)

An electrolyte was prepared by adding, based on 100 parts by weight of total solvent, 30 parts by weight of EC, 40 parts by weight of DMC, and 30 parts by weight of EMC, and 2 M LiPF₆ as the lithium salt.

### Comparative Preparation Example 12: IBN/DMC/FEC/VC+LiPF₆ (IBN:DMC=5:5, FEC:VC=8:2, 2 M)

An electrolyte was prepared by adding, based on 100 parts by weight of total solvent, 45 parts by weight of isobutyronitrile (IBN) and 45 parts by weight of dimethyl carbonate (DMC) as the primary solvent system, 8 parts by weight of fluoro-ethylene carbonate (FEC) and 2 parts by weight of vinylene carbonate (VC) as the secondary solvent system, and 2 M LiPF₆ as the lithium salt.

The electrolyte compositions of Preparation Examples, Reference Preparation Examples, and Comparative Preparation Examples above are summarized in Table 1.

TABLE 1

| | primary solvent | secondary solvent | Lithium |
|---|---|---|---|
| | (parts by weight, | (parts by weight, | salt |
| No. | ratio) | ratio) | (M) |
| Preparation | IBN/DMC (90, 4:6) | FEC/VC (10, 8:2) | LiPF₆ (1) |
| Example 1 | | | |
| Preparation | IBN/DMC (90, 5:5) | FEC/VC (10, 8:2) | LiPF₆ (1) |
| Example 2 | | | |
| Preparation | IBN/DMC (90, 6:4) | FEC/VC (10, 8:2) | LiPF₆ (1) |
| Example 3 | | | |
| Preparation | IBN/EMC (90, 5:5) | FEC/VC (10, 8:2) | LiPF₆ (1) |
| Example 4 | | | |
| Preparation | IBN/DMC (92, 5:5) | EC/FEC (8, 4:4) | LiPF₆ (1) |
| Example 5 | | | |
| Preparation | IBN/DMC (90, 5:5) | EC/VC (10, 8:2) | LiPF₆ (1) |
| Example 6 | | | |
| Preparation | IBN/DMC (90, 5:5) | FEC/VC (10, 8:2) | LiPF₆ (0.6) |
| Example 7 | | | |
| Preparation | IBN/DMC (90, 5:5) | FEC/VC (10, 8:2) | LiPF₆ (1.2) |
| Example 8 | | | |
| Reference | IBN (92) | FEC (8) | LiPF₆ (1) |
| Preparation | | | |
| Example 1 | | | |
| Comparative | EC/DMC/EMC (3:4:3) | | LiPF₆ (1) |
| Preparation | | | |
| Example 1 | | | |
| Comparative | AN (92) | FEC (8) | LiPF₆ (1) |
| Preparation | | | |
| Example 2 | | | |
| Comparative | n-BN (92) | FEC (8) | LiPF₆ (1) |
| Preparation | | | |
| Example 3 | | | |
| Comparative | CPC (92) | FEC (8) | LiPF₆ (1) |
| Preparation | | | |
| Example 4 | | | |
| Comparative | PN (92) | FEC (8) | LiPF₆ (1) |
| Preparation | | | |
| Example 5 | | | |
| Comparative | IBN/DMC (92, 5:5) | EC (8) | LiPF₆ (1) |
| Preparation | | | |
| Example 6 | | | |
| Comparative | IBN/DMC (92, 5:5) | FEC (8) | LiPF₆ (1) |
| Preparation | | | |
| Example 7 | | | |
| Comparative | IBN/DMC (92, 5:5) | VC (8) | LiPF₆ (1) |
| Preparation | | | |
| Example 8 | | | |
| Comparative | EC/DMC/EMC (3:4:3) | | LiPF₆ (0.6) |
| Preparation | | | |
| Example 9 | | | |
| Comparative | EC/DMC/EMC (3:4:3) | | LiPF₆ (1.2) |
| Preparation | | | |
| Example 10 | | | |
| Comparative | EC/DMC/EMC (3:4:3) | | LiPF₆ (2) |
| Preparation | | | |
| Example 11 | | | |
| Comparative | IBN/DMC (90, 5:5) | FEC/VC (10, 8:2) | LiPF₆ (2) |
| Preparation | | | |
| Example 12 | | | |

### Preparation of Lithium-Ion Secondary Battery

### Example 1: Lithium-Ion Secondary Battery

A negative electrode active material slurry was prepared by mixing graphite negative electrode active material (Showa Denko, Japan), a carbon conductive material (Denka Black), and polyvinylidene fluoride (PVdF) at a weight ratio of 93:2:5, together with N-mnethyl-2-pyrroIidone (NMP), in an agate mortar. The negative electrode active material slurry was coated onto a 10 μm-thick copper current collector at a thickness of approximately 130 μm using a doctor blade, dried in a hot-air dryer at 100° C. for 0.5 hours, further dried under vacuum at 120° C. for 4 hours, and then roll-pressed to produce a negative electrode plate. The density of the negative electrode was 1.2 g/cm3.

### Preparation of Positive Electrode

A positive electrode active material slurry was prepared by mixing LiNi0.8Co0.1Al0.1O2 positive electrode active material, a carbon conductive material (Denka Black), and polyvinylidene fluoride (PVdF) at a weight ratio of 94:3:3, together with N-methyl-2-pyrrolidone (NMP), in an agate mortar. The positive electrode active material slurry was coated onto a 15 μm-thick aluminum current collector at a thickness of approximately 90 μm using a doctor blade, dried at room temperature, further dried under vacuum at 120° C., and then roll-pressed to form a positive electrode having a positive electrode active material layer disposed on the current collector. The density of the positive electrode was 3.0 g/cm3.

### Manufacture of Lithium-Ion Secondary Battery

A negative electrode was punched into a circle having a diameter of 15 mm, and a positive electrode was punched into a circle having a diameter of 14 mm. The negative and positive electrodes were then dried under vacuum at 60° C. for 12 hours using a vacuum oven. The electrolyte prepared in Preparation Example 1 was used as the electrolyte. A separator having a thickness of 14 μm, composed of a polyethylene-polypropylene copolymer, was punched into a circle with a diameter of 19 mm and used. A 2032 coin cell in full-cell form was assembled using the positive electrode, the negative electrode, the electrolyte, and the separator.

### Examples 2 to 8: Lithium-Ion Secondary Battery

A 2032 coin cell in full-cell form was prepared in the same manner as in Example 1, except that the electrolytes prepared in Preparation Examples 1 to 8 were used, respectively.

### Reference Example 1: Lithium-Ion Secondary Battery

A 2032 coin cell in full-cell form was prepared in the same manner as in Example 1, except that the electrolyte prepared in Reference Preparation Example 1 was used as the electrolyte.

### Comparative Examples 1 to 12: Lithium-Ion Secondary Battery

A 2032 coin cell in full-cell form was prepared in the same manner as in Example 1, except that the electrolytes prepared in Comparative Preparation Examples 1 to 12 were used, respectively.

### Evaluation of Electrochemical Performance

### Evaluation Example 1: Charging Rate Characteristics of Nitrile Solvent (Primary Solvent)

The lithium-ion secondary batteries (coin cells) prepared in Reference Example 1 and Comparative Examples 1 to 5 were charged at 25° C. with a constant current of 0.1 C until the voltage reached 4.20 V (vs. Li) and then charged at a constant voltage of 4.20 V until the current decreased to 0.05 C, at which point the charging was cut off.

The cells were then discharged at a constant current of 0.1 C until the voltage reached 2.8 V (vs. Li) (formation stage, 1st cycle). This charge-discharge procedure was repeated two additional times to complete the formation process.

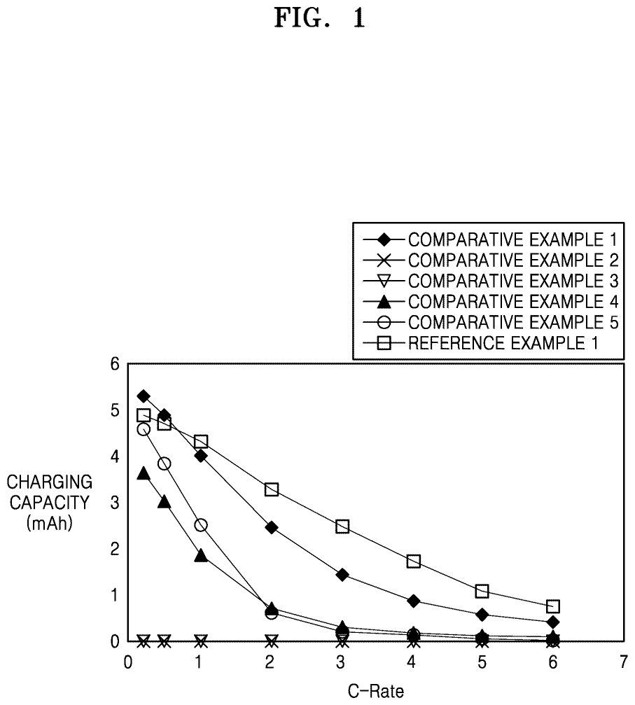

Next, the lithium-ion secondary batteries prepared in Reference Example 1 and Comparative Examples 1-5, having undergone the above formation stage, were charged at 25° C. from 2.8V to 4.2V (vs. Li) at a constant current of 0.2 C, and then discharged at a constant current of 1.2 mA until the voltage reached 2.8 V (cut-off voltage) at 0.2 C. Subsequently, the charging rate characteristics were evaluated by measuring the charging capacity at increasing C-rates of 1.0 C, 2.0 C, 3.0 C, 4.0 C, 5.0 C, and 6.0 C. The term “C-rate” refers to the inverse of the current that fully charges the battery in one hour. The results are shown in FIG. 1.

Referring to FIG. 1, only the lithium-ion secondary battery including the electrolyte including isobutyronitrile (a secondary nitrile) solvent prepared in Reference Example 1 exhibited superior charging rate characteristics compared with the lithium-ion secondary battery including the electrolyte including EC/DMC/EMC carbonate solvent prepared in Comparative Example 1. The lithium-ion secondary batteries including electrolytes including AN or n-BN (as primary nitrile) solvents, respectively prepared in Comparative Examples 2 and 3, were electrochemically unstable. The PN (a tertiary nitrile) prepared in Comparative Example 5 was electrochemically stable, however the electrolyte showed lower charging rate characteristics.

### Evaluation Example 2: Evaluation of High-Rate Charging Characteristics According to the Weight Ratio of the Primary Solvent

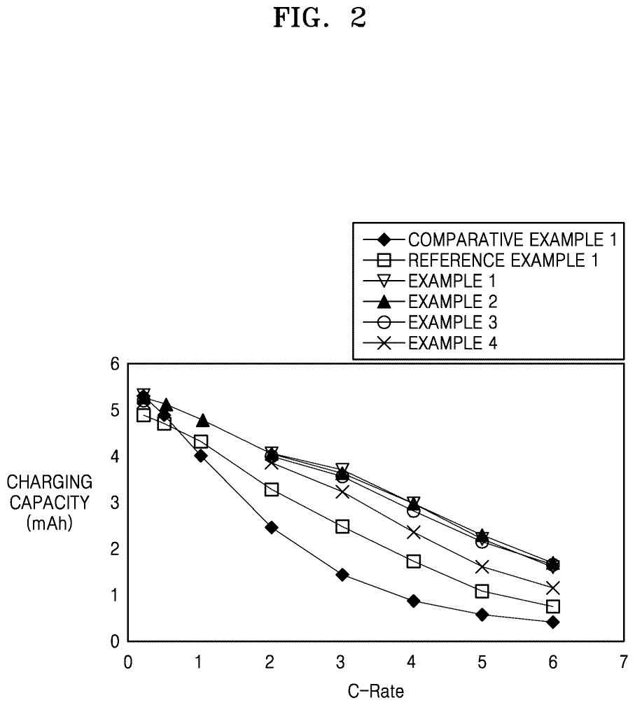

For the lithium-ion secondary batteries (coin cells) prepared in Examples 1 to 4, Reference Example 1, and Comparative Example 1, the same method as in ‘Evaluation Example 1’ was carried out to measure the charging capacity at increasing C-rates of 0.2 C, 1.0 C, 2.0 C, 3.0 C, 4.0 C, 5.0 C, and 6.0 C, to evaluate the high-rate charging characteristics. The results are shown in FIG. 2. The high-rate charging characteristics were calculated according to Equation 1 below. The results are shown in Table 2.

TABLE 2

| | 0.2 C Charging | 3 C Charging | High-rate charging |
|---|---|---|---|
| | capacity | capacity | characteristic |
| No. | (mAh) | (mAh) | (%) |
| Example 1 | 5.3 | 3.6 | 67.9 |
| Example 2 | 5.2 | 3.6 | 69.2 |
| Example 3 | 5.2 | 3.6 | 69.2 |
| Example 4 | 5.2 | 3.2 | 61.5 |
| Reference | 4.9 | 2.5 | 51.0 |
| Example 1 | | | |
| Comparative | 5.3 | 1.5 | 28.3 |
| Example 1 | | | |

$$High - rate charging characteristic ( \% ) = [ ( 3 C charging capacity / 0.2 C charging capacity ) \times 100 \% ] \qquad Equation 1$$

Referring to FIG. 2 and Table 2, the lithium-ion secondary batteries (coin cells) prepared in Examples 1 to 4 showed a high-rate charging characteristics of at least 61.5% or above, which is superior to that of the lithium-ion secondary batteries (coin cells) prepared in Reference Example 1 and Comparative Example 1.

### Evaluation Example 3: Evaluation of High-Temperature Cycle Lifespan Characteristics and Resistance According to Composition and Weight Ratio of Additive Solvent

### (1) High-Temperature Cycle Lifespan Characteristics

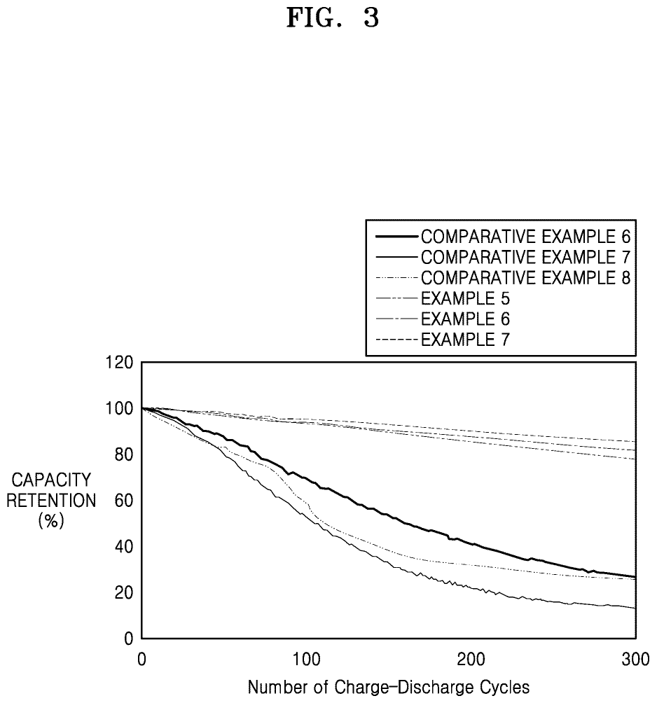

For the lithium-ion secondary batteries (coin cells) prepared in Examples 5, 6, 7 and Comparative Examples 6 to 8, which underwent the formation stage described in ‘Evaluation Example 1’, the cells were placed in a 45° C. constant-temperature chamber and charged with a current of 3 C until the voltage reached 4.20 V (vs. Li). The cells were then subjected to constant-voltage charging at 4.20 V with a current of 0.05 C and a total charging time of 20 minutes, at which point the charging was cut off. After charging, the cells were discharged at a constant current of 1.2 mA until the voltage reached the cutoff voltage of 2.8V at 0.2 C. This same charge-discharge process was then repeated 299 additional times for a total of 300 cycles. The results are shown in FIG. 3. The capacity retention rate was calculated according to Equation 2 below. The results are shown in Table 3.

$$Capacity retention ( \% ) = [ ( Discharge capcaity at 300 th cycle ) / ( Discharge capacity at 1 st cycle ) ] \times 100 ( \% ) \qquad Equation 2$$

TABLE 3

| | Discharge | Discharge | Capacity |
|---|---|---|---|
| | capacity (mAh) | capacity (mAh) | retention |
| No. | at 300th cycle | at 1st cycle | (%) |
| Example 5 | 3.23 | 4.14 | 78 |
| Example 6 | 3.38 | 4.12 | 82 |
| Example 7 | 3.48 | 4.09 | 85 |
| Comparative | 0.96 | 3.71 | 26 |
| Example 6 | | | |
| Comparative | 0.50 | 3.82 | 13 |
| Example 7 | | | |
| Comparative | 1.04 | 3.99 | 26 |
| Example 8 | | | |

Referring to FIG. 3 and Table 3, the lithium-ion secondary batteries (coin cells) prepared in Examples 5, 6, and 7 exhibited superior capacity retention compared to that of the lithium-ion secondary batteries (coin cells) prepared in Comparative Examples 6 to 8.

### (2) Room-Temperature and High-Temperature Resistance

### 1) Initial Overall Cell Resistance at Room Temperature and High Temperature

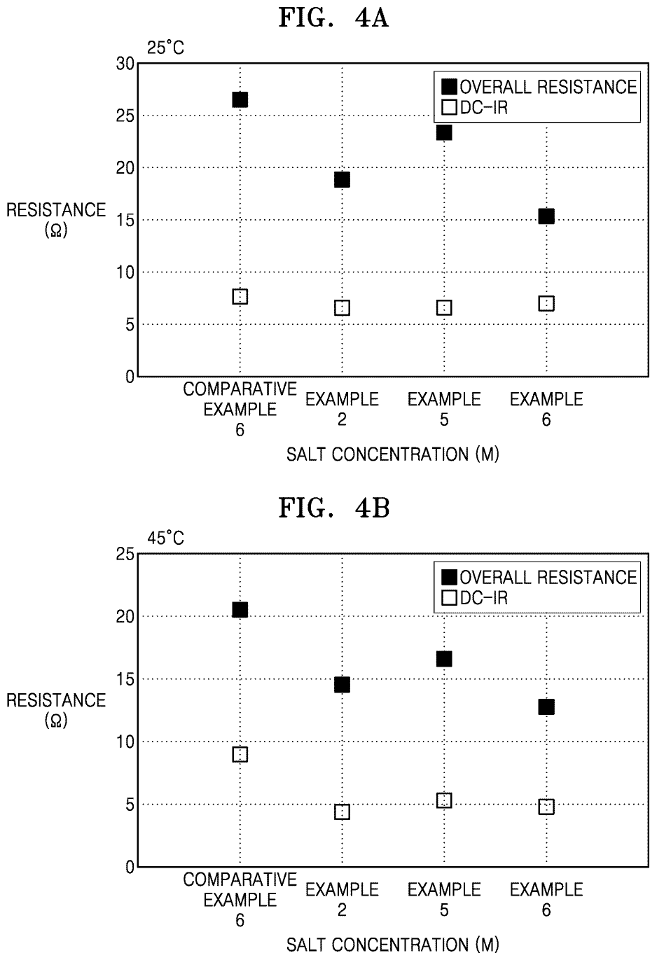

For the lithium-ion secondary batteries (coin cells) prepared in Examples 2, 5, 6 and Comparative Example 6, each battery was charged at 25° C. and 45° C. with a constant current of 3.0 C until reaching 4.2 V, and then left at open-circuit conditions for one hour. The change in the open-circuit voltage (OCV) over that hour was divided by the 3.0 C current to evaluate the initial overall cell resistance. The results are shown in FIGS. 4A and 4B.

Referring to FIGS. 4A and 4B, the initial overall cell resistance at 25° C. and 45° C. of the lithium-ion secondary batteries (coin cells) prepared in Examples 2, 5, and 6 was lower than that of the lithium-ion secondary battery (coin cell) prepared in Comparative Example 6.

### 2) Direct Current Internal Resistance (DC-IR)

After evaluating the overall cell resistance, each of the lithium-ion secondary batteries (coin cells) was discharged at 25° C. and 45° C. for 30 seconds while measuring the voltage with a voltmeter. The difference between each measured voltage and the open-circuit voltage immediately prior to discharge was divided by the current according to Ohm's law, thereby determining the direct current internal resistance (DC-IR). The results are shown in FIGS. 4A, 4B, and Table 4.

TABLE 4

| | Direct current internal | Direct current internal |
|---|---|---|
| | resistance | resistance |
| No. | (DC-IR@25° C., Ω) | (DC-IR@45° C., Ω) |
| Example 2 | 5.8 | 4.4 |
| Example 5 | 6.6 | 5.3 |
| Example 6 | 7.0 | 4.8 |
| Comparative | 7.8 | 8.9 |
| Example 6 | | |

Referring to FIGS. 4A, 4B and Table 4, under both room-temperature conditions (25° C.) and high-temperature conditions (45° C.), the overall resistance and DC-IR of the lithium-ion secondary batteries (coin cells) prepared in Examples 2, 5, 6 were lower than those of the lithium-ion secondary battery (coin cell) prepared in Comparative Example 6.

### Evaluation Example 4: Evaluation of Charging Capacity and Resistance According to Concentration of Lithium Salt

### (1) Charging Capacity

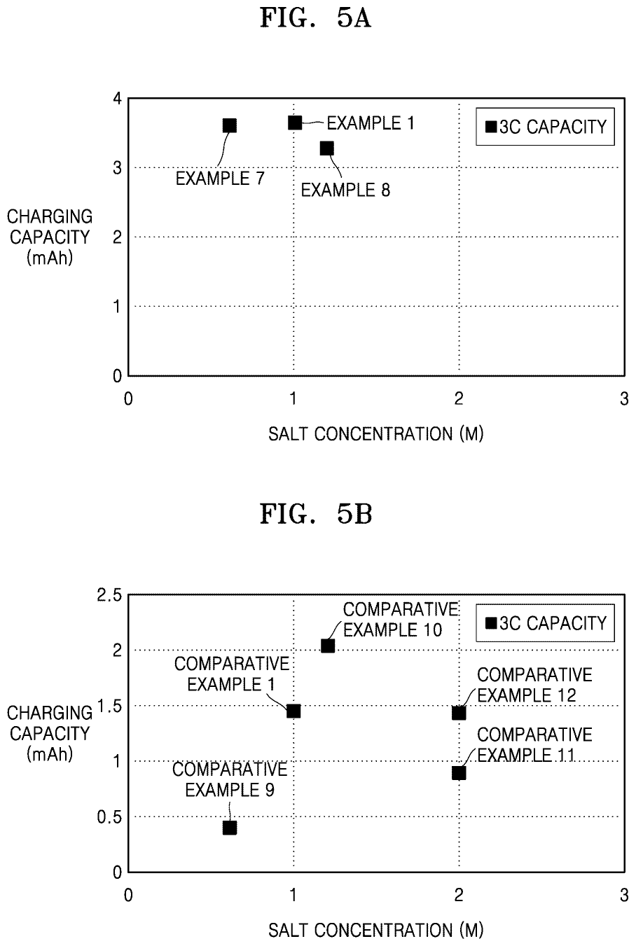

For the lithium-ion secondary batteries (coin cells) prepared in Examples 1, 7, and 8 and Comparative Examples 1 and 9 to 12, the same procedure as in ‘Evaluation Example 1’ was performed, and the charging capacities at 3.0 C-rate were measured to evaluate charging capacity. The results are shown in FIGS. 5A and 5B.

Referring to FIGS. 5A and 5B, the lithium-ion secondary batteries (coin cells) prepared in Examples 1, 7, and 8 exhibited an improved charging capacity compared with the lithium-ion secondary batteries (coin cells) prepared in Comparative Examples 1 and 9 to 12.

### (2) Room-Temperature Resistance

### (1) Initial Overall Cell Resistance at Room Temperature

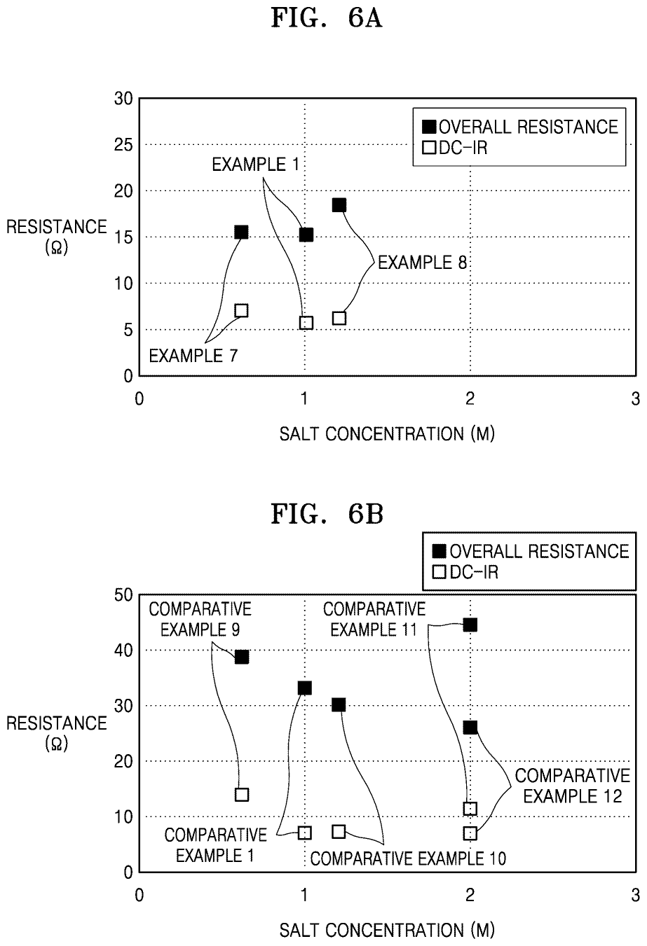

For the lithium-ion secondary batteries (coin cells) prepared in Examples 1, 7, and 8 and Comparative Examples 1 and 9 to 12, each battery was charged at 25° C. with a constant current of 3.0 C until the voltage reached 4.2V, and then left at open-circuit conditions for one hour. The change in the open-circuit voltage (OCV) over that hour was divided by the 3.0 C current to evaluate the initial overall cell resistance. The results are shown in FIGS. 6A and 6B.

### (2) Direct Current Internal Resistance (DC-IR)

After evaluating the overall cell resistance, each of the lithium-ion secondary batteries (coin cells) was discharged at 25° C. for 30 seconds while measuring the voltage with a voltmeter. The difference between each measured voltage and the open-circuit voltage immediately prior to discharge was then divided by the current according to Ohm's law to obtain the DC-IR. The results are shown in FIGS. 6A, 6B, and Table 5.

TABLE 5

| | Direct current internal resistance |
|---|---|
| No. | (DC-IR, Ω) |
| Example 1 | 5.8 |
| Example 7 | 7.1 |
| Example 8 | 6.3 |
| Comparative Example 1 | 6.8 |
| Comparative Example 9 | 13.9 |
| Comparative Example 10 | 7.5 |
| Comparative Example 11 | 11.6 |
| Comparative Example 12 | 7.8 |

Referring to FIGS. 6A, 6B and Table 5, the overall resistance and DC-IR of the lithium-ion secondary batteries (coin cells) prepared in Examples 1, 7, and 8 were generally lower than those of the lithium-ion secondary batteries (coin cells) prepared in Comparative Examples 1 and 9-12. From this result, it can be confirmed that the lithium-ion secondary batteries (coin cells) according to an embodiment exhibit improved rapid charging performance in high-energy-density electrodes.

According to an aspect, the electrolyte includes a primary solvent system including a nitrile solvent represented by Formula 1 described above and one or more linear carbonate solvents, and a secondary solvent system including two or more cyclic carbonate solvents, wherein the content of the primary solvent system may be about 90 parts by weight to about 99.9 parts by weight based on 100 parts by weight of total solvent, and the content of the nitrile solvent may be about 20 parts by weight to about 70 parts by weight based on 100 parts by weight of the total solvent.

When a high rate and high current are applied during charging using high-energy-density electrodes, an alkali-ion secondary battery containing the above electrolyte can provide an improvement in not only electrochemical stability, but also reduce the initial cell resistance and direct current internal resistance (DC-IR) at room temperature and high temperature. As a result, an alkali-ion secondary battery can exhibit enhanced cell performance such as charging capacity and high-temperature cycle lifespan characteristics.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An electrolyte comprising:
a primary solvent system comprising a nitrile solvent represented by Formula 1 and a linear carbonate solvent; and
a secondary solvent system comprising two or more cyclic carbonate solvents,
wherein a content of the primary solvent system is about 90 parts by weight to about 99.9 parts by weight, based on 100 parts by weight of total solvent, and
a content of the nitrile solvent is about 20 parts by weight to about 70 parts by weight, based on 100 parts by weight of the total solvent: 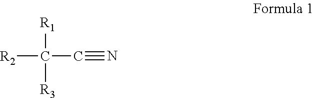
wherein in Formula 1,
one of R₁, R₂, and R₃ is hydrogen, and
two of R₁, R₂, and R₃ are independently an unsubstituted C1-C3 alkyl group.

2. The electrolyte of claim 1,
wherein the nitrile solvent comprises one or more nitrile solvents selected from isobutyronitrile, 2-methylbutanenitrile, 2,2-dimethylbutanenitrile, 2-ethylbutanenitrile, 2-ethylpentanenitrile, or 2-propylpentanenitrile.

3. The electrolyte of claim 1,
wherein the nitrile solvent has a molecular weight of about 50 g/mol to about 150 g/mol.

4. The electrolyte of claim 1,
wherein the linear carbonate solvent comprises one or more solvents selected from dimethyl carbonate (DMC), diethyl carbonate (DEC), ethyl methyl carbonate (EMC), dipropyl carbonate (DPC), methyl propyl carbonate (MPC), ethyl propyl carbonate (EPC), methyl ethyl carbonate (MEC), methyl propionate (MP), ethyl propionate (EP), or propyl propionate (PP).

5. The electrolyte of claim 1,
wherein a weight ratio of the linear carbonate solvent to the nitrile solvent in the primary solvent system is about 3:7 to about 7:3.

6. The electrolyte of claim 1,
wherein the secondary solvent system comprises two or more of ethylene carbonate (EC), propylene carbonate (PC), butylene carbonate (BC), fluoro-ethylene carbonate (FEC), vinylene carbonate (VC), and vinyl ethylene carbonate (VEC).

7. The electrolyte of claim 1, further comprising an alkali salt,
wherein a concentration of the alkali salt is less than about 2.0 moles per liter.

8. The electrolyte of claim 7,
wherein the alkali salt comprises one or more of LiPF₆, LiBF₄, LiSbF₆, LiAsF₆, LiClO₄, LiCF₃SO₃, Li(CF₃SO₂)₂N, LiC₄F₉SO₃, LiAlO₂, LiAlC₁₄, LiN(CₓF₂ₓ₊₁SO₂)(C_{y}F_{2y+1}SO₂) (where x and y are natural numbers), LiCl, Lil, lithium difluoro(oxalato)borate (LiDFOB), lithium bis(oxalato)borate (LiBOB), lithium difluoro bis(oxalato)borate (LiDFOP), lithium difluorophosphate (LiPO₂F₂), (CF₃SO₂)₂NLi, (FSO₂)₂NLi, NaClO₄, NaPF₆, NaBF₄, NaCF₃SO₃, NaN(CF₃SO₂)₂, NaN(C₂F₅SO₂)₂, or NaC(CF₃SO₂)₃.

9. The electrolyte of claim 1,
wherein the electrolyte is capable of being charged at a current of 3 C-rate or higher.

10. The electrolyte of claim 8,
wherein the nitrile solvent represented by Formula 1 comprises isobutyronitrile, and the secondary solvent system comprises fluoro-ethylene carbonate (FEC) and vinylene carbonate (VC).

11. An alkali-ion secondary battery, comprising a positive electrode, a negative electrode, and an electrolyte according to claim 1 disposed between the positive electrode and the negative electrode.

12. The alkali-ion secondary battery of claim 11,
wherein the positive electrode has a capacity of 3 milliampere-hour per square centimeter or greater per unit area.

13. The alkali-ion secondary battery of claim 11,
wherein the positive electrode comprises a positive electrode active material including an alkali metal-containing oxide.

14. The alkali-ion secondary battery of claim 12,
wherein the positive active material comprises a compound represented by Formula 11 or Formula 12: 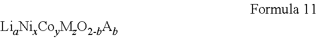
wherein in Formula 11,
a and b satisfy 1.0≤a≤1.2 and 0≤b≤0.2,
x, y and z satisfy 0.6≤x<1, 0<y≤0.3, 0<z≤0.3, and x+y+z=1,
M is one or more elements of manganese (Mn), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), or boron (B), and
A, if present, is F, S, Cl, Br, or a combination thereof, 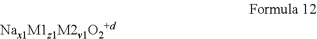
wherein in Formula 12,
M1 is at least one element of iron (Fe), manganese (Mn), cobalt (Co), nickel (Ni), ruthenium (Ru), osmium (Os), chromium (Cr), molybdenum (Mo), or tungsten (W),
M2 is at least one element of Groups 4, 5, 7, 9, or 10 of the Periodic Table of the Elements, and
x1, z1, v1, and d satisfy 0.3≤x1<2, 0<z1≤5, 0≤v1≤0.7, and 0≤d<1.

15. The alkali-ion secondary battery of claim 11,
wherein the negative electrode comprises a negative electrode active material selected from a silicon-based compound, a carbon-based compound, a composite of a silicon-based compound and a carbon-based compound, silicon oxide, where SiOₓ, 0<x<2, or a combination thereof.

16. The alkali-ion secondary battery of claim 15,
wherein the negative electrode comprises the carbon-based compound, and the carbon-based compound comprises carbon nanotubes, carbon black, graphite, or a combination thereof.

17. The alkali-ion secondary battery of claim 11, further comprising a separator disposed between the positive electrode and the negative electrode,
wherein the separator has a thickness of less than 20 micrometers.

18. The alkali-ion secondary battery of claim 11,
wherein the battery is capable of being charged at a current in a range of about 0.2 C-rate to about 6 C-rate.

19. The alkali-ion secondary battery of claim 11
is a lithium-ion secondary battery, a sodium-ion secondary battery, or a potassium-ion secondary battery.

20. A method of preparing an alkali-ion secondary battery, the method comprising:
providing a positive electrode comprising a positive electrode active material comprising an alkali metal-containing oxide;
providing a negative electrode comprising a negative electrode active material comprising an anode active material selected from a silicon-based compound, a carbon-based compound, a composite of a silicon-based compound and a carbon-based compound, and silicon oxide where SiOₓ, 0<x<2, or a combination thereof; and
providing an electrolyte between the positive electrode and the negative electrode, wherein the electrolyte comprises:
a primary solvent system comprising a nitrile solvent represented by Formula 1 and a linear carbonate solvent; and
a secondary solvent system comprising two or more cyclic carbonate solvents,
wherein a content of the primary solvent system is about 90 parts by weight to about 99.9 parts by weight, based on 100 parts by weight of total solvent, and
a content of the nitrile solvent is about 20 parts by weight to about 70 parts by weight, based on 100 parts by weight of the total solvent: 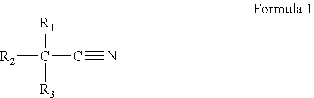
wherein in Formula 1,
one of R₁, R₂, and R₃ is hydrogen, and
two of R₁, R₂, and R₃ are independently an unsubstituted C1-C3 alkyl group.
